(19) United States
(12) Patent Application Publication
(10) Pub. No.: US 2026/0252648 A1
(43) Pub. Date: Aug. 27, 2026

(54) SYSTEM

(71) Applicant: SoftBank Group Corp., Tokyo (JP)

(72) Inventor: Kyoko FUJITA, Tokyo (JP)

(73) Assignee: SoftBank Group Corp., Tokyo (JP)

(21) Appl. No.: 19/536,282

(22) Filed: Feb. 11, 2026

(30) Foreign Application Priority Data
Feb. 21, 2025 (JP) 2025-027019

(51) Int. Cl. G06F 16/9535; G06F 40/30; G06Q 10/40; G06Q 30/02

(52) U.S. Cl. CPC G06F 16/9535; G06F 40/30; G06Q 10/40; G06Q 30/02

(57) ABSTRACT

The system according to the embodiment comprises a registration unit, a collection unit, an analysis unit, a rewriting unit, and a provision unit. The registration unit registers a user's nationality, gender, education level, and IT literacy level. The collection unit acquires information from various information media based on the information registered by the registration unit. The analysis unit analyzes the information acquired by the collection unit. The rewriting unit rewrites the information analyzed by the analysis unit into a form suitable for the user. The provision unit provides the information rewritten by the rewriting unit to the user.

### CROSS-REFERENCE TO RELATED APPLICATION

The present application claims priority to and incorporates by reference the entire contents of Japanese Patent Application No. 2025-027019 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, acquisition and provision of information tailored to the user's background have not been sufficiently performed, leaving room for improvement.

### SUMMARY OF THE INVENTION

The system according to the embodiment comprises a registration unit, a collection unit, an analysis unit, a rewriting unit, and a provision unit. The registration unit registers a user's nationality, gender, education level, and IT literacy level. The collection unit acquires information from various information media based on the information registered by the registration unit. The analysis unit analyzes the information acquired by the collection unit. The rewriting unit rewrites the information analyzed by the analysis unit into a form suitable for the user. The provision unit provides the information rewritten by the rewriting unit to the user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

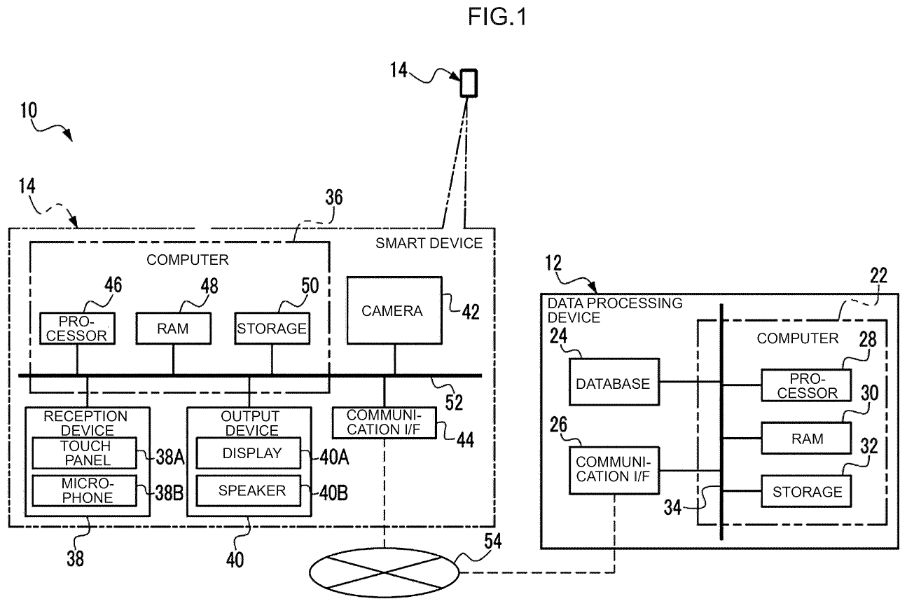

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

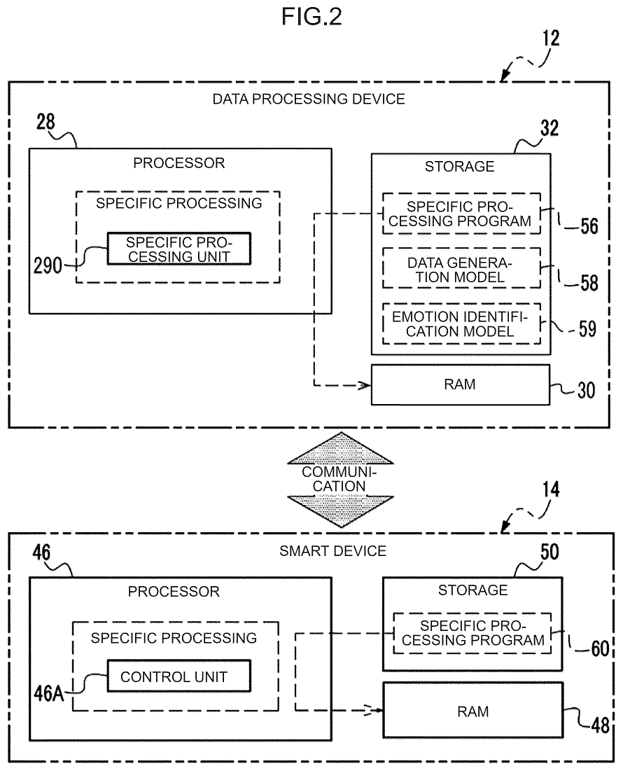

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The information accessibility platform according to the embodiment of the present invention is a system that allows a user to register their nationality, gender, education level, and IT literacy level, acquire information from various information media, and perform optimal rewriting of the information. This system enables the user to register their nationality, gender, education level, and IT literacy level. Next, a generative AI acquires information from various information media. Thereafter, the generative AI analyzes the acquired information and rewrites it into a form optimal for the user. Finally, the generative AI provides the rewritten information to the user. For example, the user registers their nationality, gender, education level, and IT literacy level. Next, the generative AI acquires information from information media such as news articles, academic papers, and blog articles. Thereafter, the generative AI analyzes the acquired information and selects appropriate information based on the user's registration information. Furthermore, the generative AI converts information containing many technical terms into words that are easily understood by the general public. Finally, the generative AI provides the rewritten information to the user. As a result, the user can acquire information regardless of their background, thereby realizing a fair and equitable information society. Thus, the information accessibility platform enables users to acquire information regardless of their background and realize a fair and equitable information society. Specifically, the information accessibility platform transmits attribute information such as nationality, gender, education level, and IT literacy at the time of user registration to the server as structured data (e.g., attribute vectors in JSON format, each attribute represented by a numerical or categorical value, e.g., nationality=2, gender=1, education level=3, IT literacy=4) via an input interface such as a web form or mobile app. The system stores these attribute vectors in a user profile database and uses them as personalization conditions for subsequent information acquisition and rewriting processes. Next, the system uses an information collection module (collection unit) to collect text data from various information media such as news articles, academic papers, and blog articles using methods such as web APIs, RSS feeds, or scraping. The collected data is temporarily stored, for example, as UTF-8 encoded text files or as tensors divided by paragraph (e.g., N×L character ID arrays, N=number of articles, L=maximum token length). Next, the system uses a large language model (e.g., transformer-based encoder-decoder model with 1 billion to 100 billion parameters) as the analysis unit, and inputs a multi-input tensor combining the user attribute vector and the collected text tensor (e.g., attribute vector length 4+text token sequence). Specific examples include Input 1: nationality=2, gender=1, education level=3, IT literacy=4+“full text of the latest academic paper on AI technology”; Input 2: nationality=1, gender=2, education level=1, IT literacy=2+“full text of a local news article”, and so on. The large language model can use pre-trained weights and additionally perform fine-tuning based on user attributes (e.g., attribute-conditioned loss functions, learning different output styles for each attribute). The model performs multi-stage processing such as extracting important terms from input text, estimating the difficulty of technical terms, and transforming writing style (e.g., technical→plain, long text→summary), and generates output text optimized for user attributes (e.g., replacing difficult terms with plain words, generating summaries, adjusting sentence endings and expressions for each attribute). Output examples include Output 1: “This paper explains the latest AI technology. AI refers to artificial intelligence.”; Output 2: “This news briefly summarizes a local event.”. Furthermore, the system can use the output text for threshold judgment (e.g., whether the difficulty score matches the user attributes) or as input to other modules (e.g., speech synthesis unit, diagram generation unit). These series of processes differ from simple human translation or summarization in that they realize non-conventional rule-based processing combining attribute vectors and high-dimensional text tensors, and multi-stage transformation by neural networks, thereby fundamentally improving computer technology (e.g., automation and acceleration of processing, improvement of personalization accuracy, barrier-free information access). As a technical effect, the present invention enables information provision optimized for each user, and can greatly improve comprehension, satisfaction, and utilization efficiency compared to conventional uniform information distribution. Application fields include educational support systems, administrative information distribution, medical information provision, internal information sharing in global companies, and barrier-free information access for people with disabilities.

The information accessibility platform according to the embodiment comprises a registration unit, a collection unit, an analysis unit, a rewriting unit, and a provision unit. The registration unit registers the user's nationality, gender, education level, and IT literacy level. The information registered by the user may include, for example, nationality, gender, education level, and IT literacy level, but is not limited thereto. The registration unit provides an interface for the user to input their nationality, gender, education level, and IT literacy level, for example. The collection unit acquires information from various information media based on the information registered by the registration unit. The collection unit acquires information from information media such as news articles, academic papers, and blog articles, for example. The collection unit can collect information from information sources on the Internet. The analysis unit analyzes the information acquired by the collection unit. The analysis unit analyzes the acquired information and selects appropriate information based on the user's registration information, for example. The analysis unit can analyze information using natural language processing technology. The rewriting unit rewrites the information analyzed by the analysis unit into a form optimal for the user. The rewriting unit converts information containing many technical terms into words that are easily understood by the general public, for example. The rewriting unit can convert information using generative AI. The provision unit provides the information rewritten by the rewriting unit to the user. The provision unit provides an interface for providing the rewritten information to the user, for example. Thus, the information accessibility platform according to the embodiment can acquire, analyze, rewrite, and provide information based on the user's nationality, gender, education level, and IT literacy level. Specifically, the information accessibility platform transmits attribute information such as nationality, gender, education level, and IT literacy as structured data (e.g., attribute vectors in JSON format, each attribute represented by a numerical or categorical value, e.g., nationality=2, gender=1, education level=3, IT literacy=4) to the server via an input interface such as a web form or mobile app. The system stores these attribute vectors in a user profile database and uses them as personalization conditions for subsequent information acquisition and rewriting processes. The collection unit, as an information collection module, collects text data from various information media such as news articles, academic papers, and blog articles using methods such as web APIs, RSS feeds, or scraping. The collected data is temporarily stored, for example, as UTF-8 encoded text files or as tensors divided by paragraph (e.g., N×L character ID arrays, N=number of articles, L=maximum token length). The analysis unit uses a large language model (e.g., transformer-based encoder-decoder model with 1 billion to 100 billion parameters), and inputs a multi-input tensor combining the user attribute vector and the collected text tensor (e.g., attribute vector length 4+text token sequence). Input examples include Input 1: nationality=2, gender=1, education level=3, IT literacy=4+“full text of the latest academic paper on AI technology”; Input 2: nationality=1, gender=2, education level=1, IT literacy=2+“full text of a local news article”, and so on. The large language model can use pre-trained weights and additionally perform fine-tuning based on user attributes (e.g., attribute-conditioned loss functions, learning different output styles for each attribute). The model performs multi-stage processing such as extracting important terms from input text, estimating the difficulty of technical terms, and transforming writing style (e.g., technical→plain, long text→summary), and generates output text optimized for user attributes (e.g., replacing difficult terms with plain words, generating summaries, adjusting sentence endings and expressions for each attribute). Output examples include Output 1: “This paper explains the latest AI technology. AI refers to artificial intelligence.”; Output 2: “This news briefly summarizes a local event.”. Furthermore, the rewriting unit can use the output text for threshold judgment (e.g., whether the difficulty score matches the user attributes) or as input to other modules (e.g., speech synthesis unit, diagram generation unit). These series of processes differ from simple human translation or summarization in that they realize non-conventional rule-based processing combining attribute vectors and high-dimensional text tensors, and multi-stage transformation by neural networks, thereby fundamentally improving computer technology (e.g., automation and acceleration of processing, improvement of personalization accuracy, barrier-free information access). As a technical effect, the present invention enables information provision optimized for each user, and can greatly improve comprehension, satisfaction, and utilization efficiency compared to conventional uniform information distribution. Application fields include educational support systems, administrative information distribution, medical information provision, internal information sharing in global companies, and barrier-free information access for people with disabilities.

The registration unit can estimate the user's emotion and adjust the input interface for registration information based on the estimated emotion of the user. For example, if the user is feeling stressed, the registration unit provides a simple interface and minimizes the input steps. If the user is relaxed, the registration unit can provide detailed input options and propose customizable input methods. Furthermore, if the user is in a hurry, the registration unit can prioritize voice input to enable quick registration of information. By adjusting the input interface according to the user's emotion, the user can register information without stress. Emotion estimation is realized using, for example, an emotion engine or generative AI with emotion estimation functions. The generative AI may be a text generation AI (e.g., LLM) or a multimodal generative AI, but is not limited thereto. Specifically, the registration unit acquires the user's input behavior (e.g., input speed, frequency of input errors, number of input interruptions) and biometric information (e.g., facial images, voice tone, heart rate data) from sensors, cameras, microphones, etc., and inputs these as input tensors (e.g., time-series numerical arrays, image tensors, acoustic feature vectors) to an emotion estimation model. Input examples include Input 1: time-series array of keyboard input speed+facial image tensor; Input 2: mel spectrogram of voice waveform+time-series heart rate data, and so on. The emotion estimation model may use a convolutional neural network (CNN), a recurrent neural network (RNN), or a multimodal fusion transformer model. The model outputs emotion labels such as “stress,” “relaxation,” “tension,” “excitement,” and probability distributions (e.g., stress level 0.8, relaxation level 0.1, etc.) from the input data. Output examples include Output 1: emotion label “stress”; Output 2: emotion label “relaxation”+probability distribution, and so on. The registration unit performs threshold judgment on these output results, automatically switching the layout of the interface and input steps, such as reducing the number of input items when the stress level is high and displaying detailed settings when the relaxation level is high. As a result, optimal UI/UX can be provided in real time according to the user's emotional state, yielding technical effects such as improved user experience, reduced input errors, and increased registration completion rate. Unlike conventional static interface design, dynamic emotion-adaptive UI control by AI can greatly improve the flexibility and adaptability of computer technology. Application fields include stress-free information registration in medical and welfare fields, learner-adaptive forms in educational settings, and stress detection-type registration systems for customer support.

The registration unit can analyze the user's past registration history and propose an optimal registration method. For example, the registration unit automatically displays information that the user has frequently entered in the past as candidates. The registration unit can also preferentially propose input methods (such as voice or text) that the user has used in the past. Furthermore, the registration unit can predict and propose information to be used at specific times based on the user's past registration history. By analyzing the user's past registration history, the registration unit can propose optimal registration methods and realize efficient information registration. Some or all of the above-described processing in the registration unit may be performed using AI or without using AI. Specifically, the registration unit acquires registration history data recorded in time series for each user (e.g., input item ID, input value, input method, input time, terminal type, etc.) from a database, and inputs these as feature vectors or time-series tensors (e.g., N×F matrix, N=number of history records, F=number of features) to an analysis module. Input examples include Input 1: input item ID column for the past 30 days+input method column+time column; Input 2: number of voice inputs in the past week+number of text inputs+input trends by day of the week, and so on. The analysis module may use decision trees, random forests, LSTM (long short-term memory) networks for time-series prediction, or clustering algorithms. The model generates outputs such as “items to be recommended for the next input,” “recommended input method,” and “predicted input time slot” from the input data. Output examples include Output 1: recommended items “nationality,” “gender”; Output 2: recommended input method “voice input”; Output 3: recommended time slot “18:00-20:00,” and so on. The registration unit uses these output results to realize automatic completion of candidate items, prioritized display of input methods, and reminder notifications for input timing on the user interface. As a result, personalized input assistance based on the user's past behavior patterns becomes possible, yielding technical effects such as improved input efficiency, reduced input errors, and increased user satisfaction. Unlike conventional uniform input forms, combining AI-based history analysis and dynamic proposal functions enables intelligent automation and optimization of the information registration process by computers. Application fields include auto-completion-type application systems for administrative procedures, individually optimized medical questionnaires, and member registration linked to purchase history on e-commerce sites.

The registration unit can customize input items at the time of registration based on the user's current situation and areas of interest. For example, the registration unit enables the user to preferentially input information related to their current occupation. The registration unit can also automatically display related input items based on the user's areas of interest. Furthermore, the registration unit can propose appropriate input items according to the user's current situation (such as student or working adult). By customizing input items based on the user's current situation and areas of interest, optimal information registration for the user can be realized. Some or all of the above-described processing in the registration unit may be performed using AI or without using AI. Specifically, the registration unit acquires attribute data such as the user's current occupation, areas of interest, learning history, and affiliated organization as structured vectors (e.g., occupation=3, area of interest=5, affiliation=2, etc. as categorical values), and inputs these as input features to a customization algorithm. Input examples include Input 1: occupation “engineer”+area of interest “AI”+affiliation “company”; Input 2: occupation “student”+area of interest “music”+affiliation “university,” and so on. The customization algorithm may use a rule-based mapping table or a neural network (e.g., multilayer perceptron) that takes attribute vectors as input. The model outputs a “list of input items to be preferentially displayed” or a “list of items to be hidden” from the input data. Output examples include Output 1: priority items “programming experience,” “languages used”; Output 2: priority items “major field,” “grade,” and so on. The registration unit dynamically controls the order and visibility of input items on the user interface based on these output results, generating an input screen optimized for the user's situation and interests. As a result, unnecessary input burden for the user is reduced, and only necessary information can be efficiently registered, yielding technical effects such as faster input operations, reduced errors, and increased user satisfaction. Unlike conventional static input form design, realizing attribute-adaptive UI generation by AI can greatly improve the flexibility and personalization of the information registration process by computers. Application fields include job-hunting support systems, learning management systems, and member registration for professionals.

The registration unit can estimate the user's emotion and adjust the order of input for registration information based on the estimated emotion of the user. For example, if the user is nervous, the registration unit prompts the user to input important information first and detailed information later. If the user is relaxed, the registration unit can prompt the user to input detailed information first and important information later. Furthermore, if the user is in a hurry, the registration unit can prompt the user to input the most important information first and supplementary information later. By adjusting the order of input according to the user's emotion, the user can efficiently register information. Emotion estimation is realized using, for example, an emotion engine or generative AI with emotion estimation functions. The generative AI may be a text generation AI (e.g., LLM) or a multimodal generative AI, but is not limited thereto. Specifically, the registration unit acquires the user's input behavior and biometric information (e.g., input speed, facial expression, voice tone, etc.) from sensors, cameras, microphones, etc., and inputs these as input tensors (e.g., time-series arrays, image tensors, acoustic feature vectors) to an emotion estimation model. Input examples include Input 1: facial image tensor+keyboard input speed; Input 2: voice spectrogram+number of input interruptions, and so on. The emotion estimation model may use CNN, RNN, or multimodal fusion transformers. The model outputs emotion labels such as “nervous,” “relaxed,” “in a hurry,” and probability distributions from the input data. Output examples include Output 1: emotion label “nervous”; Output 2: emotion label “relaxed”+probability distribution, and so on. The registration unit performs threshold judgment on these output results, automatically switching the order of input items, such as displaying important items first when the nervousness level is high and displaying detailed items first when the relaxation level is high. As a result, optimal input order can be provided in real time according to the user's emotional state, yielding technical effects such as improved input efficiency, reduced input errors, and increased registration completion rate. Unlike conventional static input order design, dynamic emotion-adaptive input control by AI can greatly improve the flexibility and adaptability of computer technology. Application fields include stress-adaptive input for medical questionnaires, learner-adaptive forms in educational settings, and emotion detection-type registration systems for customer support.

The registration unit can preferentially display highly relevant input items at the time of registration in consideration of the user's geographic location information. For example, if the user lives in a specific region, the registration unit enables the user to input information related to that region preferentially. If the user is traveling, the registration unit can enable the user to input information related to their current location preferentially. Furthermore, if the user lives in a specific city, the registration unit can enable the user to input information related to that city preferentially. By considering the user's geographic location information, highly relevant information can be preferentially input. Some or all of the above-described processing in the registration unit may be performed using AI or without using AI. Specifically, the registration unit acquires geographic location data (e.g., latitude and longitude pairs, city codes, country codes, etc.) in real time from the user's device's GPS sensor, IP address, Wi-Fi access point information, etc., and transmits these as structured vectors (e.g., latitude=35.6, longitude=139.7, city=3, country=1, etc.) to the server. The system stores these location vectors in the user profile database and uses them as priority control conditions for input items. The registration unit inputs a combination of geographic location vectors and user attribute vectors (e.g., occupation, areas of interest, etc.) as multidimensional features to a customization algorithm. Input examples include Input 1: latitude 35.6, longitude 139.7, city=3+occupation=2+area of interest=5; Input 2: latitude 34.7, longitude 135.5, city=2+occupation=1+area of interest=3, and so on. The customization algorithm may use a rule-based mapping table or a neural network (e.g., multilayer perceptron, model combining geographic clustering) that takes geographic features as input. The model outputs a “list of input items to be preferentially displayed” or a “list of items to be hidden” from the input data. Output examples include Output 1: priority items “participation in local events,” “local contact information”; Output 2: priority items “purpose of travel,” “length of stay,” and so on. The registration unit dynamically controls the order and visibility of input items on the user interface based on these output results, generating an input screen optimized for the user's geographic situation. Furthermore, variations such as automatic updating or re-proposal of input items according to the frequency and accuracy of geographic location information acquisition can also be implemented. As a result, unnecessary input burden for the user is reduced, and only necessary information can be efficiently registered, yielding technical effects such as faster input operations, reduced errors, and increased user satisfaction. Unlike conventional static input form design, realizing geographic-adaptive UI generation by AI can greatly improve the flexibility and personalization of the information registration process by computers. Application fields include member registration for region-limited services, tourist information systems, local information registration during disasters, and location-based information management for global companies.

The registration unit can analyze the user's social media activity at the time of registration and propose relevant input items. For example, the registration unit proposes relevant input items based on the content that the user frequently posts on social media. The registration unit can also analyze the user's social media friendships and propose relevant input items. Furthermore, the registration unit can analyze the user's social media activity history and propose relevant input items. By analyzing the user's social media activity, relevant input items can be proposed, enabling efficient information registration. Some or all of the above-described processing in the registration unit may be performed using AI or without using AI. Specifically, with the user's permission, the registration unit acquires post history data (e.g., post text, post time, hashtags, location information), friend lists, group participation information, etc. from major social media APIs, and inputs these as structured data (e.g., N×F matrix, N=number of posts, F=number of features) or text tensors (e.g., token sequence for each post) to an analysis module. Input examples include Input 1: post text for the past 30 days+hashtags+post time; Input 2: friend relationship graph+group participation history, and so on. The analysis module may use a large language model for natural language processing (e.g., transformer-based encoder), graph neural networks (GNN), or clustering algorithms. The model extracts “user's areas of interest,” “frequent keywords,” “characteristics of friend networks,” etc. from the input data, and outputs a “recommended input item list” or “priority input method” based on these. Output examples include Output 1: recommended items “hobbies,” “event participation history”; Output 2: recommended items “occupation,” “specialty field”; Output 3: recommended input method “voice input,” and so on. The registration unit uses these output results to realize automatic completion of candidate items, prioritized display of input methods, and reminder notifications for input timing on the user interface. Furthermore, combining sentiment analysis and topic modeling of post content enables more precise personalized proposals. As a result, personalized input assistance based on the user's social media activity becomes possible, yielding technical effects such as improved input efficiency, reduced input errors, and increased user satisfaction. Unlike conventional uniform input forms, combining AI-based social data analysis and dynamic proposal functions enables intelligent automation and optimization of the information registration process by computers. Application fields include SNS-linked member registration, service recommendations based on hobbies and areas of interest, and automatic profile generation for community sites.

The collection unit can estimate the user's emotion and adjust the timing of information collection based on the estimated emotion of the user. For example, if the user is relaxed, the collection unit collects information slowly. If the user is in a hurry, the collection unit can collect information quickly. Furthermore, if the user is excited, the collection unit can collect information quickly and efficiently. By adjusting the timing of information collection according to the user's emotion, efficient information collection can be realized. Emotion estimation is realized using, for example, an emotion engine or generative AI with emotion estimation functions. The generative AI may be a text generation AI (e.g., LLM) or a multimodal generative AI, but is not limited thereto. Specifically, the collection unit acquires the user's input behavior (e.g., mouse operation speed, click frequency, number of input interruptions) and biometric information (e.g., facial images, voice tone, skin conductance, etc.) from sensors, cameras, microphones, etc., and inputs these as input tensors (e.g., time-series numerical arrays, image tensors, acoustic feature vectors) to an emotion estimation model. Input examples include Input 1: time-series array of mouse movement speed+facial image tensor; Input 2: mel spectrogram of voice waveform+time-series skin conductance data, and so on. The emotion estimation model may use convolutional neural networks (CNN), recurrent neural networks (RNN), or multimodal fusion transformer models. The model outputs emotion labels such as “relaxation,” “in a hurry,” “excitement,” and probability distributions (e.g., relaxation level 0.7, in a hurry level 0.2, etc.) from the input data. Output examples include Output 1: emotion label “relaxation”; Output 2: emotion label “in a hurry”+probability distribution, and so on. The collection unit performs threshold judgment on these output results, automatically adjusting the timing of information collection, such as lengthening the collection interval when the relaxation level is high and increasing the collection frequency when the in a hurry level is high. Furthermore, variations such as optimizing the priority of information collection and the number of concurrent collections according to the emotional state can also be implemented. As a result, optimal information collection timing can be provided in real time according to the user's emotional state, yielding technical effects such as improved efficiency of information acquisition, enhanced user experience, and optimized system load. Unlike conventional static information collection scheduling, dynamic emotion-adaptive collection control by AI can greatly improve the flexibility and adaptability of computer technology. Application fields include stress-free information collection in medical and welfare fields, learner-adaptive information acquisition in educational settings, and emotion detection-type information collection systems for customer support.

The collection unit can analyze the user's past information collection history and select an optimal collection method. For example, the collection unit proposes an optimal collection method based on information that the user has frequently collected in the past. The collection unit can also select an efficient collection method based on the user's past information collection history. Furthermore, the collection unit can analyze the user's past information collection history and propose the most appropriate collection method. By analyzing the user's past information collection history, the collection unit can select an optimal collection method and realize efficient information collection. Some or all of the above-described processing in the collection unit may be performed using AI or without using AI. Specifically, the collection unit acquires information collection history data recorded in time series for each user (e.g., collection target ID, collection method, collection time, collection media, collection success rate, etc.) from a database, and inputs these as feature vectors or time-series tensors (e.g., N×F matrix, N=number of history records, F=number of features) to an analysis module. Input examples include Input 1: collection target ID column for the past 30 days+collection method column+time column; Input 2: number of API collections in the past week+number of scraping operations+collection trends by day of the week, and so on. The analysis module may use decision trees, random forests, LSTM (long short-term memory) networks for time-series prediction, or clustering algorithms. The model generates outputs such as “recommended collection method for the next collection,” “recommended collection target,” and “predicted collection time slot” from the input data. Output examples include Output 1: recommended method “API collection”; Output 2: recommended target “news articles,” “academic papers”; Output 3: recommended time slot “18:00-20:00,” and so on. The collection unit uses these output results to realize automatic switching of methods, prioritized display of targets, and reminder notifications for collection timing on the information collection module. Furthermore, by considering history such as collection failure rate and response time, more efficient optimization of collection methods is also possible. As a result, personalized information collection assistance based on the user's past behavior patterns becomes possible, yielding technical effects such as improved efficiency of collection operations, reduced collection errors, and increased user satisfaction. Unlike conventional uniform information collection methods, combining AI-based history analysis and dynamic proposal functions enables intelligent automation and optimization of the information collection process by computers. Application fields include automatic collection systems for administrative information, individually optimized collection of medical information, and information collection linked to purchase history on e-commerce sites.

The collection unit can perform filtering during information collection in consideration of the user's current areas of interest. For example, the collection unit preferentially collects information related to the areas in which the user is currently interested. The collection unit can also filter related information based on the user's areas of interest. Furthermore, the collection unit can collect optimal information based on the user's current areas of interest. By filtering information based on the user's current areas of interest, highly relevant information can be collected. Some or all of the above-described processing in the collection unit may be performed using AI or without using AI. Specifically, the collection unit acquires data on areas of interest input by the user (e.g., category ID, keyword list, past browsing history, etc.) as structured vectors (e.g., category=5, keywords=“AI, medical,” etc.), and inputs these as input features to an information collection algorithm. Input examples include Input 1: category “AI”+keyword “natural language processing”; Input 2: category “music”+keyword “composition,” and so on. The information collection algorithm may use rule-based filtering, keyword matching, or a neural network (e.g., multilayer perceptron, model combining topic modeling) that takes area of interest vectors as input. The model outputs a “list of information to be preferentially collected” or a “list of information to be excluded” from the input data. Output examples include Output 1: priority information “latest AI technology news,” “medical AI application cases”; Output 2: excluded information “entertainment articles,” and so on. The collection unit automatically selects collection targets and optimizes the order of collection on the information collection module based on these output results, realizing information collection optimized for the user's interests. Furthermore, variations such as detecting changes in areas of interest in real time and dynamically switching collection targets can also be implemented. As a result, unnecessary information collection for the user is suppressed, and only necessary information can be efficiently acquired, yielding technical effects such as faster information collection operations, reduced noise, and increased user satisfaction. Unlike conventional static information collection design, realizing area of interest-adaptive information collection by AI can greatly improve the flexibility and personalization of the information collection process by computers. Application fields include personalized news distribution, information collection by specialty field, and automatic collection of learning materials for learners.

The collection unit can estimate the user's emotion and determine the priority of information to be collected based on the estimated emotion of the user. For example, if the user is nervous, the collection unit preferentially collects important information. If the user is relaxed, the collection unit can preferentially collect detailed information. Furthermore, if the user is in a hurry, the collection unit can preferentially collect the most important information. By determining the priority of information according to the user's emotion, important information can be preferentially collected. Emotion estimation is realized using, for example, an emotion engine or generative AI with emotion estimation functions. The generative AI may be a text generation AI (e.g., LLM) or a multimodal generative AI, but is not limited thereto. Specifically, the collection unit acquires the user's input behavior (e.g., mouse operation speed, click frequency, number of input interruptions) and biometric information (e.g., facial images, voice tone, skin conductance, etc.) from sensors, cameras, microphones, etc. in real time, and inputs these as input tensors (e.g., time-series numerical arrays, image tensors, acoustic feature vectors) to an emotion estimation model. For example, the collection unit may use Input 1: time-series array of mouse movement speed+facial image tensor; Input 2: mel spectrogram of voice waveform+time-series skin conductance data, and so on. The emotion estimation model may use convolutional neural networks (CNN), recurrent neural networks (RNN), or multimodal fusion transformer models. The model outputs emotion labels such as “nervous,” “relaxed,” “in a hurry,” and probability distributions (e.g., nervousness level 0.7, relaxation level 0.2, etc.) from the input data. Output examples include Output 1: emotion label “nervous”; Output 2: emotion label “relaxed” +probability distribution; Output 3: emotion label “in a hurry”+probability distribution, and so on. The collection unit performs threshold judgment on these output results, automatically adjusting the priority of the information collection queue, such as preferentially collecting information with a high “importance score” (e.g., urgent news, business communications) when the nervousness level is high, preferentially collecting detailed information (e.g., explanatory articles, supplementary materials) when the relaxation level is high, and preferentially collecting the most important information (e.g., summaries, breaking news) when the in a hurry level is high. Importance judgment of information may involve assigning metadata (e.g., source reliability, information freshness, user interest score, etc.) to each collection target and inputting these as multidimensional feature vectors to a priority estimation algorithm (e.g., decision tree, random forest, neural network, etc.). The model outputs a “priority collection list” or “deferred list” from the input data, and the collection unit dynamically controls the order of information collection and the number of concurrent collections based on this. Furthermore, variations such as automatic switching of collection targets and optimization of collection frequency according to the combination of emotion estimation results and information importance scores can also be implemented. These series of processes differ from simple human prioritization in that they realize non-conventional rule-based processing combining emotional state and high-dimensional information features, and multi-stage optimization by neural networks, thereby fundamentally improving computer technology (e.g., automation and acceleration of information collection, improvement of personalization accuracy, optimization of system load). As a technical effect, the present invention enables optimal control of information collection priority for each user, and can greatly improve the efficiency of acquiring necessary information, satisfaction, and system responsiveness compared to conventional uniform information collection. Application fields include stress-adaptive information collection in medical and welfare fields, learner-adaptive information acquisition in educational settings, emotion detection-type information collection systems for customer support, and priority collection of emergency information during disasters.

The collection unit can preferentially collect highly relevant information during information collection in consideration of the user's geographic location information. For example, if the user lives in a specific region, the collection unit preferentially collects information related to that region. If the user is traveling, the collection unit can preferentially collect information related to their current location. Furthermore, if the user lives in a specific city, the collection unit can preferentially collect information related to that city. By considering the user's geographic location information, highly relevant information can be preferentially collected. Some or all of the above-described processing in the collection unit may be performed using AI or without using AI. Specifically, the collection unit acquires geographic location data (e.g., latitude and longitude pairs, city codes, country codes, etc.) in real time from the user's device's GPS sensor, IP address, Wi-Fi access point information, etc., and transmits these as structured vectors (e.g., latitude=35.6, longitude=139.7, city=3, country=1, etc.) to the server. The system stores these location vectors in the user profile database and uses them as priority control conditions for information collection. The collection unit inputs a combination of geographic location vectors and user attribute vectors (e.g., occupation, areas of interest, etc.) as multidimensional features to an information collection algorithm. Input examples include Input 1: latitude 35.6, longitude 139.7, city=3+occupation=2+area of interest=5; Input 2: latitude 34.7, longitude 135.5, city=2+occupation=1+area of interest=3, and so on. The information collection algorithm may use a rule-based mapping table or a neural network (e.g., multilayer perceptron, model combining geographic clustering) that takes geographic features as input. The model outputs a “list of information to be preferentially collected” or a “list of information to be excluded” from the input data. Output examples include Output 1: priority information “local event information,” “local news”; Output 2: priority information “tourist information for travel destinations,” “local weather information,” and so on. The collection unit automatically selects collection targets and optimizes the order of collection on the information collection module based on these output results, realizing information collection optimized for the user's geographic situation. Furthermore, variations such as automatic updating or re-proposal of collection targets according to the frequency and accuracy of geographic location information acquisition can also be implemented. As a result, unnecessary information collection for the user is suppressed, and only necessary information can be efficiently acquired, yielding technical effects such as faster information collection operations, reduced noise, and increased user satisfaction. Unlike conventional static information collection design, realizing geographic-adaptive information collection by AI can greatly improve the flexibility and personalization of the information collection process by computers. Application fields include information collection for region-limited services, tourist information systems, local information collection during disasters, and location-based information management for global companies.

The collection unit can analyze the user's social media activity during information collection and collect relevant information. For example, the collection unit collects relevant information based on the content that the user frequently posts on social media. The collection unit can also analyze the user's social media friendships and collect relevant information. Furthermore, the collection unit can analyze the user's social media activity history and collect relevant information. By analyzing the user's social media activity, relevant information can be efficiently collected. Some or all of the above-described processing in the collection unit may be performed using AI or without using AI. Specifically, with the user's permission, the collection unit acquires post history data (e.g., post text, post time, hashtags, location information), friend lists, group participation information, etc. from major social media APIs, and inputs these as structured data (e.g., N×F matrix, N=number of posts, F=number of features) or text tensors (e.g., token sequence for each post) to an analysis module. Input examples include Input 1: post text for the past 30 days+hashtags+post time; Input 2: friend relationship graph+group participation history, and so on. The analysis module may use a large language model for natural language processing (e.g., transformer-based encoder), graph neural networks (GNN), or clustering algorithms. The model extracts “user's areas of interest,” “frequent keywords,” “characteristics of friend networks,” etc. from the input data, and outputs a “recommended information collection list” or “priority collection method” based on these. Output examples include Output 1: recommended information “hobby-related news,” “event participation information”; Output 2: recommended information “specialty field articles,” “information related to friends' posts,” and so on. The collection unit uses these output results to realize automatic selection of candidate information, prioritized display of collection methods, and reminder notifications for collection timing on the information collection module. Furthermore, combining sentiment analysis and topic modeling of post content enables more precise personalized proposals. As a result, personalized information collection assistance based on the user's social media activity becomes possible, yielding technical effects such as improved efficiency of collection operations, reduced collection errors, and increased user satisfaction. Unlike conventional uniform information collection methods, combining AI-based social data analysis and dynamic proposal functions enables intelligent automation and optimization of the information collection process by computers. Application fields include SNS-linked information collection, news collection according to hobbies and areas of interest, and automatic information collection for community sites.

The analysis unit can estimate the user's emotion and adjust the method of information analysis based on the estimated emotion of the user. For example, if the user is relaxed, the analysis unit performs detailed analysis. If the user is in a hurry, the analysis unit can perform rapid analysis. Furthermore, if the user is excited, the analysis unit can perform efficient analysis. By adjusting the method of information analysis according to the user's emotion, efficient information analysis can be realized. Emotion estimation is realized using, for example, an emotion engine or generative AI with emotion estimation functions. The generative AI may be a text generation AI (e.g., LLM) or a multimodal generative AI, but is not limited thereto. Specifically, the analysis unit acquires the user's input behavior (e.g., input speed, frequency of input errors, number of input interruptions) and biometric information (e.g., facial images, voice tone, heart rate data) from sensors, cameras, microphones, etc., and inputs these as input tensors (e.g., time-series numerical arrays, image tensors, acoustic feature vectors) to an emotion estimation model. Input examples include Input 1: time-series array of keyboard input speed+facial image tensor; Input 2: mel spectrogram of voice waveform+time-series heart rate data, and so on. The emotion estimation model may use convolutional neural networks (CNN), recurrent neural networks (RNN), or multimodal fusion transformer models. The model outputs emotion labels such as “relaxation,” “in a hurry,” “excitement,” and probability distributions (e.g., relaxation level 0.7, in a hurry level 0.2, etc.) from the input data. Output examples include Output 1: emotion label “relaxation”; Output 2: emotion label “in a hurry”+probability distribution; Output 3: emotion label “excitement”+probability distribution, and so on. The analysis unit performs threshold judgment on these output results, automatically switching the analysis pipeline, such as executing detailed analysis (e.g., multi-stage summarization, keyword extraction, sentiment analysis, etc.) when the relaxation level is high, executing rapid analysis (e.g., key point extraction, short summary, etc.) when the in a hurry level is high, and executing efficient analysis (e.g., high-speed analysis by parallel processing, importance scoring, etc.) when the excitement level is high. These series of processes differ from simple human selection of analysis procedures in that they realize non-conventional rule-based processing combining emotional state and high-dimensional input features, and multi-stage optimization by neural networks, thereby fundamentally improving computer technology (e.g., automation and acceleration of analysis processing, improvement of personalization accuracy, optimization of system load). As a technical effect, the present invention enables optimal control of information analysis methods for each user, and can greatly improve analysis efficiency, satisfaction, and responsiveness compared to conventional uniform information analysis. Application fields include stress-adaptive information analysis in medical and welfare fields, learner-adaptive analysis in educational settings, and emotion detection-type information analysis systems for customer support.

The analysis unit can adjust the level of detail of analysis during analysis based on the importance of the information. For example, the analysis unit performs detailed analysis for important information. The analysis unit can also perform simplified analysis for general information. Furthermore, the analysis unit can adjust the level of detail of analysis based on the user's level of interest. By adjusting the level of detail of analysis based on the importance of the information, efficient information analysis can be realized. Some or all of the above-described processing in the analysis unit may be performed using AI or without using AI. Specifically, the analysis unit receives text data and metadata (e.g., source reliability, information freshness, user interest score, etc.) from the collection unit as input tensors (e.g., N×F matrix, N=number of information items, F=number of features), and combines these with user profile vectors (e.g., areas of interest, past browsing history, importance threshold, etc.) as input to the analysis pipeline. Input examples include Input 1: news article text+importance score 0.9+user interest 0.8; Input 2: blog article text+importance score 0.3+user interest 0.2, and so on. When the importance score or interest score is high, the analysis unit executes multi-stage analysis using a transformer-based large language model (e.g., summary generation, keyword extraction, sentiment analysis, causal relationship extraction, etc.), and when the scores are low, applies lightweight processing such as simple key point extraction or keyword listing. The internal AI model can dynamically control the depth of analysis and output content using loss functions or attention masks conditioned on importance and interest. Output examples include Output 1: detailed summary+list of important terms+sentiment score; Output 2: simple summary+only main keywords, and so on. The analysis unit passes these outputs to the subsequent rewriting unit or provision unit, realizing optimal information presentation according to user attributes and usage conditions. These series of processes differ from simple human importance judgment or manual analysis in that they realize non-conventional rule-based processing combining multidimensional information features and user profiles, and multi-stage optimization by neural networks, thereby fundamentally improving computer technology (e.g., automation and acceleration of analysis processing, improvement of personalization accuracy, optimization of system load). As a technical effect, the present invention enables optimal control of the level of detail of information analysis for each user, and can greatly improve analysis efficiency, satisfaction, and responsiveness compared to conventional uniform information analysis. Application fields include priority analysis of important information in medical and welfare fields, learner-adaptive analysis in educational settings, and importance-adaptive information analysis systems for customer support.

The analysis unit can apply different analysis algorithms during analysis according to the category of the information. For example, the analysis unit applies a dedicated analysis algorithm for news articles. The analysis unit can also apply a dedicated analysis algorithm for academic papers. Furthermore, the analysis unit can apply a dedicated analysis algorithm for blog articles. By applying different analysis algorithms according to the category of the information, efficient information analysis can be realized. Some or all of the above-described processing in the analysis unit may be performed using AI or without using AI. Specifically, the analysis unit receives category labels (e.g., news, academic paper, blog, etc.) attached to text data from the collection unit as metadata, and inputs these as input tensors (e.g., N×F matrix, N=number of information items, F=number of features+category ID) to an analysis algorithm selection module. Input examples include Input 1: category “news”+article text; Input 2: category “academic paper”+paper text; Input 3: category “blog”+article text, and so on. The analysis unit automatically selects and switches pipelines for AI models optimized for each category (e.g., for news: summary generation+sentiment analysis; for academic papers: citation extraction+technical term explanation; for blogs: speaker emotion analysis+topic classification, etc.). The internal AI model applies category-conditioned pre-training and fine-tuning, and uses different loss functions and output formats for each category to balance analysis accuracy and efficiency. Output examples include Output 1: news summary+emotion score; Output 2: paper summary+citation list+technical term explanation; Output 3: blog summary+speaker emotion+topic classification, and so on. The analysis unit passes these outputs to the subsequent rewriting unit or provision unit, realizing optimal information presentation according to user attributes and usage conditions. These series of processes differ from manual analysis for each category by humans in that they realize non-conventional rule-based processing combining information category and high-dimensional features, and multi-stage optimization by neural networks, thereby fundamentally improving computer technology (e.g., automation and acceleration of analysis processing, improvement of personalization accuracy, optimization of system load). As a technical effect, the present invention enables optimal control of analysis algorithms for each information category, and can greatly improve analysis efficiency, accuracy, and user satisfaction compared to conventional uniform information analysis. Application fields include category-specific analysis for news distribution services, academic information search systems, and automatic summarization and classification for blog platforms.

The analysis unit can estimate the user's emotion and adjust the display method of analysis results based on the estimated emotion of the user. For example, if the user is nervous, the analysis unit provides a simple and highly visible display method. If the user is relaxed, the analysis unit can provide a display method that includes detailed information. Furthermore, if the user is in a hurry, the analysis unit can provide a display method that highlights key points. By adjusting the display method of analysis results according to the user's emotion, the optimal display method for the user can be provided. Emotion estimation is realized using, for example, an emotion engine or generative AI with emotion estimation functions. The generative AI may be a text generation AI (e.g., LLM) or a multimodal generative AI, but is not limited thereto. Specifically, the analysis unit acquires the user's input behavior (e.g., mouse operation speed, click frequency, number of input interruptions) and biometric information (e.g., facial images, voice tone, heart rate data) from sensors, cameras, microphones, etc., and inputs these as input tensors (e.g., time-series numerical arrays, image tensors, acoustic feature vectors) to an emotion estimation model. Input examples include Input 1: time-series array of keyboard input speed+facial image tensor; Input 2: mel spectrogram of voice waveform+time-series heart rate data, and so on. The emotion estimation model may use convolutional neural networks (CNN), recurrent neural networks (RNN), or multimodal fusion transformer models. The model outputs emotion labels such as “nervous,” “relaxed,” “in a hurry,” and probability distributions (e.g., nervousness level 0.7, relaxation level 0.2, etc.) from the input data. Output examples include Output 1: emotion label “nervous”; Output 2: emotion label “relaxed”+probability distribution; Output 3: emotion label “in a hurry”+probability distribution, and so on. The analysis unit performs threshold judgment on these output results, automatically switching the display method, such as providing a simple card-type UI or emphasizing display with large fonts and color coding when the nervousness level is high, providing a rich UI with detailed graphs and supplementary explanations when the relaxation level is high, and displaying only key points in a bulleted list when the in a hurry level is high. Furthermore, variations such as dynamically selecting the optimal display template by combining the user's emotional state and past display history can also be implemented. These series of processes differ from simple human switching of display methods in that they realize non-conventional rule-based processing combining emotional state and high-dimensional input features, and multi-stage optimization by neural networks, thereby fundamentally improving computer technology (e.g., automatic optimization of UI/UX, improved user experience, reduced errors). As a technical effect, the present invention enables optimal control of analysis result display for each user, and can greatly improve comprehension, satisfaction, and utilization efficiency compared to conventional uniform display. Application fields include stress-adaptive information display in medical and welfare fields, learner-adaptive UI in educational settings, and emotion detection-type information presentation systems for customer support.

The analysis unit can determine the priority of analysis during analysis based on the submission timing of the information. For example, the analysis unit preferentially analyzes the latest information. The analysis unit can also analyze older information later. Furthermore, the analysis unit can determine the priority of analysis based on the user's level of interest. By determining the priority of analysis based on the submission timing of the information, efficient information analysis can be realized. Some or all of the above-described processing in the analysis unit may be performed using AI or without using AI. Specifically, the analysis unit receives submission time metadata (e.g., timestamp, transmission date and time, etc.) attached to text data from the collection unit and user profile vectors (e.g., areas of interest, past browsing history, priority threshold, etc.) as input tensors (e.g., N×F matrix, N=number of information items, F=number of features+time value) to a priority determination algorithm. Input examples include Input 1: submission time “2024-Jun.-01”+interest level 0.9+article text; Input 2: submission time “2023-Dec.-15”+interest level 0.2+article text, and so on. The priority determination algorithm may use rule-based time comparison, LSTM networks for time-series prediction, or a neural network (e.g., multilayer perceptron) that takes submission time and interest level as input. The model outputs a “priority analysis list” or “deferred list” from the input data, and the analysis unit dynamically controls the order of analysis and the number of concurrent analyses based on this. Furthermore, variations such as automatic switching of analysis pipelines and optimal allocation of analysis resources according to the combination of submission timing and user interest level can also be implemented. These series of processes differ from simple human prioritization by time series in that they realize non-conventional rule-based processing combining submission timing, interest level, and high-dimensional features, and multi-stage optimization by neural networks, thereby fundamentally improving computer technology (e.g., automation and acceleration of analysis processing, improvement of personalization accuracy, optimization of system load). As a technical effect, the present invention enables optimal control of analysis priority based on information submission timing, and can greatly improve analysis efficiency, responsiveness, and user satisfaction compared to conventional uniform information analysis. Application fields include priority analysis of breaking news, emergency communication systems, and priority analysis of the latest teaching materials in educational settings.

The analysis unit can adjust the order of analysis based on the relevance of information during analysis. For example, the analysis unit preferentially analyzes highly relevant information. Additionally, the analysis unit may postpone the analysis of less relevant information. Furthermore, the analysis unit can also adjust the order of analysis based on the user's level of interest. By adjusting the order of analysis based on the relevance of information, efficient information analysis can be achieved. Some or all of the above-described processes in the analysis unit may be performed using AI, or may be performed without using AI. Specifically, the analysis unit inputs relevance scores between multiple text data received from the information collection unit (e.g., cosine similarity, number of co-occurring keywords, topic match degree) and user profile vectors (e.g., areas of interest, past browsing history, relevance threshold) as input tensors (e.g., N×N matrix, N=number of information items, element=relevance score) to a relevance analysis algorithm. Examples of input include: Input 1: cosine similarity between Article A and Article B of 0.85+user interest level of 0.9; Input 2: topic match degree between Article C and Article D of 0.2+user interest level of 0.3; and so on. As relevance analysis algorithms, graph neural networks (GNN), clustering algorithms, or neural networks that take relevance scores as input (e.g., multilayer perceptron) can be used. The model outputs a “priority analysis list” and a “postponed list” from the input data, and the analysis unit dynamically controls the order of analysis and the number of concurrent analyses based on these outputs. Examples of output include: Output 1: priority analysis of “related news group” and “articles on the same topic”; Output 2: postponed analysis of “low relevance articles”; and so on. Furthermore, depending on the combination of relevance scores and user interest levels, automatic switching of the analysis pipeline and optimal allocation of analysis resources can also be implemented. This series of processes, which combines high-dimensional feature quantities between information and user profiles, realizes non-conventional rule-based processing and multi-stage optimization using neural networks, which is fundamentally different from simple human relevance judgment, and brings essential improvements to computer technology (e.g., automation and acceleration of analysis processing, improvement of personalization accuracy, optimization of system load). As a technical effect, the present invention achieves optimized control of analysis order based on information relevance, and can greatly improve analysis efficiency, responsiveness, and user satisfaction compared to conventional uniform information analysis. Applicable fields include topic-based news analysis, priority analysis of related literature in academic papers, and analysis of similar cases in customer support.

The rewriting unit can estimate the user's emotion and adjust the method of expression for rewriting based on the estimated emotion of the user. For example, when the user is relaxed, the rewriting unit provides an expressive method that includes detailed explanations. Additionally, when the user is in a hurry, the rewriting unit can provide a concise method of expression. Furthermore, when the user is excited, the rewriting unit can provide a visually stimulating method of expression. By adjusting the method of expression for rewriting according to the user's emotion, optimal information provision for the user can be achieved. Emotion estimation is realized, for example, by using an emotion engine or generative AI with emotion estimation functions. Generative AI may include text generation AI (e.g., LLM) or multimodal generative AI, but is not limited to these examples. Specifically, the rewriting unit acquires the user's input behavior (e.g., keyboard input speed, frequency of input errors, number of input interruptions) and biometric information (e.g., facial images, voice tone, heart rate data) in real time from sensors, cameras, microphones, etc., and inputs these as input tensors (e.g., time-series numerical arrays, image tensors, acoustic feature vectors) to an emotion estimation model. Examples of input include: Input 1: time-series array of keyboard input speed+facial image tensor; Input 2: mel spectrogram of voice waveform+time-series heart rate data; and so on. As emotion estimation models, convolutional neural networks (CNN), recurrent neural networks (RNN), and multimodal fusion transformer models can be used. The model outputs emotion labels such as “relaxed,” “in a hurry,” “excited,” and probability distributions (e.g., relaxation level 0.7, hurry level 0.2) from the input data. Examples of output include: Output 1: emotion label “relaxed”; Output 2: emotion label “in a hurry”+probability distribution; Output 3: emotion label “excited”+probability distribution; and so on. The rewriting unit performs threshold judgment on these output results, and when the relaxation level is high, generates expressions that include many detailed explanations and supplementary information (e.g., paragraph-by-paragraph commentary, explanatory text with diagrams); when the hurry level is high, generates concise expressions summarizing only the main points (e.g., bullet points, short summaries); and when the excitement level is high, generates expressions with visual effects such as color, font emphasis, and animation. The generative AI of the rewriting unit uses transformer-based large language models or multimodal generative models, and inputs a multi-input tensor combining user attribute vectors, emotion labels, and original text tensors (e.g., attribute length 4+emotion label+text token sequence). The model can use pre-trained weights and perform emotion-conditioned fine-tuning (e.g., learning different loss functions and output styles for each emotion). Examples of output include: Output 1: long text with detailed commentary; Output 2: short text with only main points; Output 3: visually emphasized text with color or icons; and so on. Furthermore, the rewriting unit passes the output text to subsequent provision units, speech synthesis units, diagram generation units, etc., to realize information presentation optimized for the user's emotional state. This series of processes, which combines emotional state and high-dimensional input features, realizes non-conventional rule-based processing and multi-stage optimization using neural networks, which is fundamentally different from simple human expression switching, and brings essential improvements to computer technology (e.g., automatic optimization of UI/UX, improvement of user experience, reduction of errors). As a technical effect, the present invention achieves optimized control of rewriting expressions for each user, and can greatly improve comprehension, satisfaction, and usage efficiency compared to conventional uniform expressions. Applicable fields include stress-adaptive information presentation in medical and welfare fields, learner-adaptive teaching material generation in educational settings, and emotion-detection-based information presentation systems in customer support.

The rewriting unit can convert technical terms in information into words that are easily understood by the general public during rewriting. For example, the rewriting unit converts technical terms in academic papers into general words. Additionally, the rewriting unit can convert technical terms in news articles into general words. Furthermore, the rewriting unit can convert technical terms in blog articles into general words. By converting technical terms in information into words that are easily understood by the general public, understanding of the information is promoted. Some or all of the above-described processes in the rewriting unit may be performed using AI, or may be performed without using AI. Specifically, the rewriting unit receives text data containing many technical terms (e.g., academic paper text, news article text, blog article text) as text tensors (e.g., N×L character ID array, N=number of sentences, L=maximum token length). Furthermore, user attribute vectors (e.g., education level, IT literacy) are combined to generate multi-input tensors. Examples of input include: Input 1: education level=1+“AI deep learning technology . . . ”; Input 2: IT literacy=2+“Superconducting qubits in quantum computers . . . ”; and so on. The rewriting unit uses transformer-based large language models and technical term dictionary-based conversion algorithms to automatically extract technical terms from input text and estimate difficulty (e.g., TF-IDF score, vocabulary difficulty dictionary reference). The model automatically replaces extracted technical terms with plain words or explanatory sentences according to user attributes, and generates text with endings and expressions adjusted according to context. Examples of output include: Output 1: “Deep learning is a technology that allows computers to learn features by themselves.”; Output 2: “Superconducting qubits are special components that operate at very low temperatures.”; and so on. Furthermore, the rewriting unit can use the output text for threshold judgment (e.g., whether the difficulty score matches the user attributes) or as input to other modules (e.g., speech synthesis unit, diagram generation unit). This series of processes, which combines technical term extraction, difficulty estimation, and context-adaptive replacement, realizes non-conventional rule-based processing and multi-stage transformation using neural networks, which is fundamentally different from simple human paraphrasing or summarization, and brings essential improvements to computer technology (e.g., automation and acceleration, improvement of personalization accuracy, information barrier-free). As a technical effect, the present invention achieves optimized technical term conversion for each user, and can greatly improve comprehension, satisfaction, and usage efficiency compared to conventional uniform information delivery. Applicable fields include educational support systems, administrative information delivery, medical information provision, internal information sharing in global companies, and barrier-free information for people with disabilities.

The rewriting unit can apply different rewriting algorithms according to the category of information during rewriting. For example, the rewriting unit applies a news-specific rewriting algorithm to news articles. Additionally, the rewriting unit can apply an academic paper-specific rewriting algorithm to academic papers. Furthermore, the rewriting unit can apply a blog-specific rewriting algorithm to blog articles. By applying different rewriting algorithms according to the category of information, efficient information rewriting can be achieved. Some or all of the above-described processes in the rewriting unit may be performed using AI, or may be performed without using AI. Specifically, the rewriting unit receives category labels (e.g., news, academic paper, blog) attached as metadata to text data received from the information collection unit or analysis unit, and inputs these as input tensors (e.g., N×F matrix, N=number of information items, F=number of features+category ID) to a rewriting algorithm selection module. Examples of input include: Input 1: category “news”+article text; Input 2: category “academic paper”+paper text; Input 3: category “blog”+article text; and so on. The rewriting unit automatically selects AI models optimized for each category (e.g., for news: summary generation+sentiment adjustment; for academic papers: technical term explanation+summary; for blogs: speaker emotion emphasis+topic classification) and switches the rewriting pipeline. Inside the AI model, category-conditioned pre-training and fine-tuning are performed, and different loss functions and output formats are used for each category to balance rewriting accuracy and efficiency. Examples of output include: Output 1: news summary+sentiment score-adjusted text; Output 2: paper summary+text with technical term explanations; Output 3: blog summary+speaker emotion-emphasized text; and so on. Furthermore, the rewriting unit passes the output text to subsequent provision units, speech synthesis units, diagram generation units, etc., to realize optimal information presentation according to user attributes and usage conditions. This series of processes, which combines information category and high-dimensional features, realizes non-conventional rule-based processing and multi-stage optimization using neural networks, which is fundamentally different from manual rewriting for each category by humans, and brings essential improvements to computer technology (e.g., automation and acceleration of rewriting processing, improvement of personalization accuracy, optimization of system load). As a technical effect, the present invention achieves optimized control of rewriting algorithms for each information category, and can greatly improve efficiency, accuracy, and user satisfaction compared to conventional uniform information rewriting. Applicable fields include category-based rewriting in news distribution services, academic information search systems, and automatic summarization/classification in blog platforms.

The rewriting unit can estimate the user's emotion and adjust the length of rewriting based on the estimated emotion of the user. For example, when the user is in a hurry, the rewriting unit performs short rewriting that covers the main points. Additionally, when the user is relaxed, the rewriting unit can perform longer rewriting that includes detailed explanations. Furthermore, when the user is excited, the rewriting unit can perform rewriting with visually stimulating effects. By adjusting the length of rewriting according to the user's emotion, optimal information provision for the user can be achieved. Emotion estimation is realized, for example, by using an emotion engine or generative AI with emotion estimation functions. Generative AI may include text generation AI (e.g., LLM) or multimodal generative AI, but is not limited to these examples. Specifically, the rewriting unit acquires the user's input behavior (e.g., keyboard input speed, frequency of input errors, number of input interruptions) and biometric information (e.g., facial images, voice tone, heart rate data) in real time from sensors, cameras, microphones, etc., and inputs these as input tensors (e.g., time-series numerical arrays, image tensors, acoustic feature vectors) to an emotion estimation model. Examples of input include: Input 1: time-series array of keyboard input speed+facial image tensor; Input 2: mel spectrogram of voice waveform+time-series heart rate data; and so on. As emotion estimation models, convolutional neural networks (CNN), recurrent neural networks (RNN), and multimodal fusion transformer models can be used. The model outputs emotion labels such as “in a hurry,” “relaxed,” “excited,” and probability distributions (e.g., hurry level 0.8, relaxation level 0.1) from the input data. Examples of output include: Output 1: emotion label “in a hurry”; Output 2: emotion label “relaxed”+probability distribution; Output 3: emotion label “excited”+probability distribution; and so on. The rewriting unit performs threshold judgment on these output results, and when the hurry level is high, generates short rewriting summarizing only the main points (e.g., bullet points, shortened summaries); when the relaxation level is high, generates long rewriting including many detailed explanations and supplementary information (e.g., paragraph-by-paragraph commentary, explanatory text with examples); and when the excitement level is high, generates rewriting with visual effects such as color, font emphasis, and animation. The generative AI of the rewriting unit uses transformer-based large language models or multimodal generative models, and inputs a multi-input tensor combining user attribute vectors, emotion labels, and original text tensors. The model can perform emotion-conditioned fine-tuning (e.g., different loss functions and output length control for each emotion). Examples of output include: Output 1: short summary text; Output 2: long text with detailed commentary; Output 3: text with visual effects; and so on. Furthermore, the rewriting unit passes the output text to subsequent provision units, speech synthesis units, diagram generation units, etc., to realize information presentation optimized for the user's emotional state. This series of processes, which combines emotional state and high-dimensional input features, realizes non-conventional rule-based processing and multi-stage optimization using neural networks, which is fundamentally different from simple human length adjustment, and brings essential improvements to computer technology (e.g., automatic optimization of UI/UX, improvement of user experience, reduction of errors). As a technical effect, the present invention achieves optimized control of rewriting length for each user, and can greatly improve comprehension, satisfaction, and usage efficiency compared to conventional uniform information presentation lengths. Applicable fields include stress-adaptive information presentation in medical and welfare fields, learner-adaptive teaching material generation in educational settings, and emotion-detection-based information presentation systems in customer support.

The rewriting unit can determine the priority of rewriting based on the submission timing of information during rewriting. For example, the rewriting unit preferentially rewrites the latest information. Additionally, the rewriting unit may postpone the rewriting of older information. Furthermore, the rewriting unit can also determine the priority of rewriting based on the user's level of interest. By determining the priority of rewriting based on the submission timing of information, efficient information rewriting can be achieved. Some or all of the above-described processes in the rewriting unit may be performed using AI, or may be performed without using AI. Specifically, the rewriting unit inputs submission time metadata (e.g., timestamp, transmission date and time) attached to text data received from the information collection unit or analysis unit, and user profile vectors (e.g., areas of interest, past browsing history, priority threshold) as input tensors (e.g., N×F matrix, N=number of information items, F=number of features+time value) to a priority determination algorithm. Examples of input include: Input 1: submission time “2024-Jun.-01”+interest level 0.9+article text; Input 2: submission time “2023-Dec.-15”+interest level 0.2+article text; and so on. As priority determination algorithms, rule-based time comparison, LSTM networks for time-series prediction, or neural networks that take submission time and interest level as input (e.g., multilayer perceptron) can be used. The model outputs a “priority rewriting list” and a “postponed list” from the input data, and the rewriting unit dynamically controls the order of rewriting and the number of concurrent rewritings based on these outputs. Examples of output include: Output 1: priority rewriting of “latest news” and “urgent notifications”; Output 2: postponed rewriting of “past reference articles”; and so on. Furthermore, depending on the combination of submission timing and user interest level, automatic switching of the rewriting pipeline and optimal allocation of rewriting resources can also be implemented. This series of processes, which combines submission timing, interest level, and high-dimensional features, realizes non-conventional rule-based processing and multi-stage optimization using neural networks, which is fundamentally different from simple human time-series prioritization, and brings essential improvements to computer technology (e.g., automation and acceleration of rewriting processing, improvement of personalization accuracy, optimization of system load). As a technical effect, the present invention achieves optimized control of rewriting priority based on information submission timing, and can greatly improve efficiency, responsiveness, and user satisfaction compared to conventional uniform information rewriting. Applicable fields include priority rewriting of news requiring promptness, emergency notification systems, and priority rewriting of the latest teaching materials in educational settings.

The rewriting unit can adjust the order of rewriting based on the relevance of information during rewriting. For example, the rewriting unit preferentially rewrites highly relevant information. Additionally, the rewriting unit may postpone the rewriting of less relevant information. Furthermore, the rewriting unit can also adjust the order of rewriting based on the user's level of interest. By adjusting the order of rewriting based on the relevance of information, efficient information rewriting can be achieved. Some or all of the above-described processes in the rewriting unit may be performed using AI, or may be performed without using AI. Specifically, the rewriting unit inputs relevance scores between multiple text data received from the information collection unit or analysis unit (e.g., cosine similarity, number of co-occurring keywords, topic match degree) and user profile vectors (e.g., areas of interest, past browsing history, relevance threshold) as input tensors (e.g., N×N matrix, N=number of information items, element=relevance score) to a relevance analysis algorithm. Examples of input include: Input 1: cosine similarity between Article A and Article B of 0.85+user interest level of 0.9; Input 2: topic match degree between Article C and Article D of 0.2+user interest level of 0.3; and so on. As relevance analysis algorithms, graph neural networks (GNN), clustering algorithms, or neural networks that take relevance scores as input (e.g., multilayer perceptron) can be used. The model outputs a “priority rewriting list” and a “postponed list” from the input data, and the rewriting unit dynamically controls the order of rewriting and the number of concurrent rewritings based on these outputs. Examples of output include: Output 1: priority rewriting of “related news group” and “articles on the same topic”; Output 2: postponed rewriting of “low relevance articles”; and so on. Furthermore, depending on the combination of relevance scores and user interest levels, automatic switching of the rewriting pipeline and optimal allocation of rewriting resources can also be implemented. This series of processes, which combines high-dimensional feature quantities between information and user profiles, realizes non-conventional rule-based processing and multi-stage optimization using neural networks, which is fundamentally different from simple human relevance judgment, and brings essential improvements to computer technology (e.g., automation and acceleration of rewriting processing, improvement of personalization accuracy, optimization of system load). As a technical effect, the present invention achieves optimized control of rewriting order based on information relevance, and can greatly improve efficiency, responsiveness, and user satisfaction compared to conventional uniform information rewriting. Applicable fields include topic-based news rewriting, priority rewriting of related literature in academic papers, and rewriting of similar cases in customer support.

The provision unit can estimate the user's emotion and adjust the method of information provision based on the estimated emotion of the user. For example, when the user is relaxed, the provision unit provides information including detailed explanations. Additionally, when the user is in a hurry, the provision unit can provide concise information. Furthermore, when the user is excited, the provision unit can provide visually stimulating information. By adjusting the method of information provision according to the user's emotion, optimal information provision for the user can be achieved. Emotion estimation is realized, for example, by using an emotion engine or generative AI with emotion estimation functions. Generative AI may include text generation AI (e.g., LLM) or multimodal generative AI, but is not limited to these examples. Specifically, the provision unit acquires the user's input behavior (e.g., mouse operation speed, click frequency, number of input interruptions) and biometric information (e.g., facial images, voice tone, heart rate data) in real time from sensors, cameras, microphones, etc., and inputs these as input tensors (e.g., time-series numerical arrays, image tensors, acoustic feature vectors) to an emotion estimation model. For example, Input 1: time-series array of keyboard input speed+facial image tensor; Input 2: mel spectrogram of voice waveform+time-series heart rate data; and so on. As emotion estimation models, convolutional neural networks (CNN), recurrent neural networks (RNN), and multimodal fusion transformer models can be used. The model outputs emotion labels such as “relaxed,” “in a hurry,” “excited,” and probability distributions (e.g., relaxation level 0.7, hurry level 0.2) from the input data. Examples of output include: Output 1: emotion label “relaxed”; Output 2: emotion label “in a hurry”+probability distribution; Output 3: emotion label “excited”+probability distribution; and so on. The provision unit performs threshold judgment on these output results, and when the relaxation level is high, generates information provision including many detailed explanations and supplementary information (e.g., paragraph-by-paragraph commentary, explanatory text with diagrams); when the hurry level is high, generates concise information provision summarizing only the main points (e.g., bullet points, short summaries); and when the excitement level is high, generates information provision with visual effects such as color, font emphasis, and animation. The generative AI of the provision unit uses transformer-based large language models or multimodal generative models, and inputs a multi-input tensor combining user attribute vectors, emotion labels, and original text tensors (e.g., attribute length 4+emotion label+text token sequence). The model can use pre-trained weights and perform emotion-conditioned fine-tuning (e.g., learning different loss functions and output styles for each emotion). Examples of output include: Output 1: long text with detailed commentary; Output 2: short text with only main points; Output 3: visually emphasized text with color or icons; and so on. Furthermore, the provision unit passes the output text to subsequent speech synthesis units, diagram generation units, etc., to realize information presentation optimized for the user's emotional state. This series of processes, which combines emotional state and high-dimensional input features, realizes non-conventional rule-based processing and multi-stage optimization using neural networks, which is fundamentally different from simple human expression switching, and brings essential improvements to computer technology (e.g., automatic optimization of UI/UX, improvement of user experience, reduction of errors). As a technical effect, the present invention achieves optimized control of information provision methods for each user, and can greatly improve comprehension, satisfaction, and usage efficiency compared to conventional uniform information provision. Applicable fields include stress-adaptive information presentation in medical and welfare fields, learner-adaptive teaching material provision in educational settings, and emotion-detection-based information presentation systems in customer support.

The provision unit can refer to the user's past information provision history to select the optimal provision method during provision. For example, the provision unit proposes the optimal provision method based on the information provision methods the user has preferred in the past. Additionally, the provision unit can select an efficient provision method from the user's past information provision history. Furthermore, the provision unit can analyze the user's past information provision history and propose the most appropriate provision method. By referring to the user's past information provision history, the optimal provision method can be selected, and efficient information provision can be achieved. Some or all of the above-described processes in the provision unit may be performed using AI, or may be performed without using AI. Specifically, the provision unit acquires information provision history data recorded in chronological order for each user (e.g., provision method ID, provision content, provision time, device type, user response) from a database, and inputs these as feature vectors or time-series tensors (e.g., N×F matrix, N=number of history items, F=number of features) to an analysis module. Examples of input include: Input 1: provision method ID column for the past 30 days+provision content column+time column; Input 2: number of voice provisions in the past week+number of text provisions+provision trends by day of the week; and so on. As analysis modules, decision trees, random forests, LSTM (long short-term memory) networks for time-series prediction, or clustering algorithms can be used. The model generates outputs such as “recommended provision method for next provision,” “recommended provision content,” and “predicted provision time slot” from the input data. Examples of output include: Output 1: recommended method “voice provision”; Output 2: recommended content “summary information,” “detailed commentary”; Output 3: recommended time slot “18:00-20:00”; and so on. The provision unit uses these output results to realize automatic switching of provision methods, priority display of content, and reminder notifications for provision timing on the user interface. Furthermore, by considering user response history (e.g., click rate, satisfaction score), more efficient optimization of provision methods is possible. This series of processes, which combines history data and high-dimensional features, realizes non-conventional rule-based processing and multi-stage optimization using neural networks, which is fundamentally different from simple human history reference, and brings essential improvements to computer technology (e.g., automation and acceleration of information provision processes, improvement of personalization accuracy, optimization of system load). As a technical effect, the present invention achieves optimized control of information provision methods for each user, and can greatly improve comprehension, satisfaction, and usage efficiency compared to conventional uniform information provision. Applicable fields include individualized optimization of administrative information delivery, history-linked presentation of medical information, and purchase history-linked information provision in e-commerce sites.

The provision unit can customize the means of information provision based on the user's current situation during provision. For example, the provision unit preferentially provides information related to the user's current occupation. Additionally, the provision unit can provide relevant information based on the user's areas of interest. Furthermore, the provision unit can provide appropriate information according to the user's current situation (e.g., student, working adult). By customizing the means of information provision based on the user's current situation, optimal information provision for the user can be achieved. Some or all of the above-described processes in the provision unit may be performed using AI, or may be performed without using AI. Specifically, the provision unit acquires attribute data entered by the user, such as current occupation, areas of interest, learning history, and affiliated organization, as structured vectors (e.g., occupation=3, area of interest=5, affiliation=2 as category values), and inputs these as input features to a customization algorithm. Examples of input include: Input 1: occupation “engineer”+area of interest “AI”+affiliation “company”; Input 2: occupation “student”+area of interest “music”+affiliation “university”; and so on. As customization algorithms, rule-based mapping tables or neural networks that take attribute vectors as input (e.g., multilayer perceptron) can be used. The model outputs a “priority information list” and a “hidden information list” from the input data. Examples of output include: Output 1: priority information “programming-related news,” “industry trends”; Output 2: priority information “teaching materials for major field,” “assignments by grade”; and so on. The provision unit dynamically controls the order and visibility of information provision means on the user interface based on these output results, generating an information screen optimized for the user's situation and interests. Furthermore, variations that detect changes in situation in real time and dynamically switch the provision content can also be implemented. This series of processes, which combines attribute vectors and high-dimensional features, realizes non-conventional rule-based processing and multi-stage optimization using neural networks, which is fundamentally different from simple manual customization by humans, and brings essential improvements to computer technology (e.g., automation and acceleration of information provision processes, improvement of personalization accuracy, optimization of system load). As a technical effect, the present invention achieves optimized control of information provision means for each user, and can greatly improve comprehension, satisfaction, and usage efficiency compared to conventional uniform information provision. Applicable fields include job search support systems, learning management systems, and information provision for professionals.

The provision unit can estimate the user's emotion and determine the priority of information provision based on the estimated emotion of the user. For example, when the user is nervous, the provision unit preferentially provides important information. Additionally, when the user is relaxed, the provision unit can preferentially provide detailed information. Furthermore, when the user is in a hurry, the provision unit can preferentially provide the most important information. By determining the priority of information provision according to the user's emotion, important information can be preferentially provided. Emotion estimation is realized, for example, by using an emotion engine or generative AI with emotion estimation functions. Generative AI may include text generation AI (e.g., LLM) or multimodal generative AI, but is not limited to these examples. Specifically, the provision unit acquires the user's input behavior (e.g., mouse operation speed, click frequency, number of input interruptions) and biometric information (e.g., facial images, voice tone, heart rate data) in real time from sensors, cameras, microphones, etc., and inputs these as input tensors (e.g., time-series numerical arrays, image tensors, acoustic feature vectors) to an emotion estimation model. For example, Input 1: time-series array of keyboard input speed+facial image tensor; Input 2: mel spectrogram of voice waveform+time-series heart rate data; and so on. As emotion estimation models, convolutional neural networks (CNN), recurrent neural networks (RNN), and multimodal fusion transformer models can be used. The model outputs emotion labels such as “nervous,” “relaxed,” “in a hurry,” and probability distributions (e.g., nervousness level 0.7, relaxation level 0.2) from the input data. Examples of output include: Output 1: emotion label “nervous”; Output 2: emotion label “relaxed”+probability distribution; Output 3: emotion label “in a hurry”+probability distribution; and so on. The provision unit performs threshold judgment on these output results, and when the nervousness level is high, preferentially provides information with a high “importance score” (e.g., urgent news, business notifications); when the relaxation level is high, preferentially provides detailed information (e.g., explanatory articles, supplementary materials); and when the hurry level is high, preferentially provides the most important information (e.g., summary, breaking news), automatically adjusting the priority of the information provision queue. Importance judgment of information is performed by assigning metadata (e.g., source reliability, information freshness, user interest score) to each provision target, and inputting these as multidimensional feature vectors to a priority estimation algorithm (e.g., decision tree, random forest, neural network). The model outputs a “priority provision list” and a “postponed list” from the input data, and the provision unit dynamically controls the order of information provision and the number of concurrent provisions based on these outputs. Furthermore, depending on the combination of emotion estimation results and information importance scores, automatic switching of provision targets and optimization of provision frequency can also be implemented. This series of processes, which combines emotional state and high-dimensional information features, realizes non-conventional rule-based processing and multi-stage optimization using neural networks, which is fundamentally different from simple human prioritization, and brings essential improvements to computer technology (e.g., automation and acceleration of information provision, improvement of personalization accuracy, optimization of system load). As a technical effect, the present invention achieves optimized control of information provision priority for each user, and can greatly improve the efficiency of obtaining necessary information, satisfaction, and system responsiveness compared to conventional uniform information provision. Applicable fields include stress-adaptive information provision in medical and welfare fields, learner-adaptive information presentation in educational settings, emotion-detection-based information provision systems in customer support, and priority provision of emergency information during disasters.

The provision unit can select the optimal information provision method by considering the user's geographic location information during provision. For example, when the user lives in a specific region, the provision unit preferentially provides information related to that region. Additionally, when the user is traveling, the provision unit can preferentially provide information related to the current location. Furthermore, when the user lives in a specific city, the provision unit can preferentially provide information related to that city. By considering the user's geographic location information, the optimal information provision method can be selected, and efficient information provision can be achieved. Some or all of the above-described processes in the provision unit may be performed using AI, or may be performed without using AI. Specifically, the provision unit acquires geographic location data (e.g., latitude-longitude pairs, city codes, country codes) in real time from the user's device GPS sensor, IP address, Wi-Fi access point information, etc., and sends these as structured vectors (e.g., latitude=35.6, longitude=139.7, city=3, country=1) to the server. The system stores these location vectors in the user profile database and uses them as priority control conditions for information provision. The provision unit inputs the geographic location vector and user attribute vector (e.g., occupation, areas of interest) as multidimensional features to the information provision algorithm. Examples of input include: Input 1: latitude 35.6, longitude 139.7, city=3+occupation=2+area of interest=5; Input 2: latitude 34.7, longitude 135.5, city=2+occupation=1+area of interest=3; and so on. As information provision algorithms, rule-based mapping tables or neural networks that take geographic features as input (e.g., multilayer perceptron, models combining geographic clustering) can be used. The model outputs a “priority information list” and an “excluded information list” from the input data. Examples of output include: Output 1: priority information “local event information,” “local news”; Output 2: priority information “travel destination sightseeing guide,” “local weather information”; and so on. The provision unit automatically selects provision targets and optimizes provision order in the information provision module based on these output results, realizing information provision optimized for the user's geographic situation. Furthermore, variations that automatically update or re-propose provision targets according to the frequency and accuracy of geographic location information acquisition can also be implemented. This series of processes, which combines geographic features and high-dimensional input features, realizes non-conventional rule-based processing and multi-stage optimization using neural networks, which is fundamentally different from simple human selection of regional information, and brings essential improvements to computer technology (e.g., automation and acceleration of information provision processes, improvement of personalization accuracy, optimization of system load). As a technical effect, the present invention achieves optimized control of geographic adaptive information provision for each user, and can greatly improve comprehension, satisfaction, and usage efficiency compared to conventional uniform information provision. Applicable fields include information provision for region-limited services, sightseeing guide systems, local information provision during disasters, and location-based information management for global companies.

The provision unit can analyze the user's social media activity to propose means of information provision during provision. For example, the provision unit provides relevant information based on the content the user frequently posts on social media. Additionally, the provision unit can analyze the user's social media friendships and provide relevant information. Furthermore, the provision unit can analyze the user's social media activity history and provide relevant information. By analyzing the user's social media activity, the optimal means of information provision can be proposed, and efficient information provision can be achieved. Some or all of the above-described processes in the provision unit may be performed using AI, or may be performed without using AI. Specifically, the provision unit, with the user's permission, acquires post history data (e.g., post text, post time, hashtags, location information), friend lists, group participation information, etc., from major social media APIs, and inputs these as structured data (e.g., N×F matrix, N=number of posts, F=number of features) or text tensors (e.g., token sequence for each post) to an analysis module. Examples of input include: Input 1: post text for the past 30 days+hashtags+post time; Input 2: friend relationship graph+group participation history; and so on. As analysis modules, large language models for natural language processing (e.g., transformer-based encoders), graph neural networks (GNN), and clustering algorithms can be used. The model extracts “user's areas of interest,” “frequent keywords,” and “characteristics of friend networks” from the input data, and outputs a “recommended provision information list” and “priority provision method” based on these. Examples of output include: Output 1: recommended information “hobby-related news,” “event participation information”; Output 2: recommended information “articles in specialized fields,” “information related to friends' posts”; and so on. The provision unit uses these output results to realize automatic selection of candidate information, priority display of provision methods, and reminder notifications for provision timing in the information provision module. Furthermore, by combining sentiment analysis of post content and topic modeling, more precise personalized proposals are possible. This series of processes, which combines social data and high-dimensional features, realizes non-conventional rule-based processing and multi-stage optimization using neural networks, which is fundamentally different from simple human history reference, and brings essential improvements to computer technology (e.g., automation and acceleration of information provision processes, improvement of personalization accuracy, optimization of system load). As a technical effect, the present invention achieves optimized control of social data-linked information provision for each user, and can greatly improve comprehension, satisfaction, and usage efficiency compared to conventional uniform information provision. Applicable fields include SNS-linked information provision, service recommendation according to hobbies and areas of interest, and automatic profile generation for community sites.

The system according to the embodiment is not limited to the above examples, and various modifications are possible, for example, as follows. Specifically, the system can flexibly change the module configuration and data flow of the registration unit, collection unit, analysis unit, rewriting unit, and provision unit. For example, variations include expanding the input interface of the registration unit to a contactless type using voice recognition or image recognition; expanding the information acquisition means of the collection unit to IoT sensor networks or external database linkage; changing the AI model of the analysis unit to a hybrid type combining multiple neural networks (e.g., CNN+RNN+Transformer); expanding the output of the rewriting unit to multilingual support or voice/diagram generation; and optimizing the information presentation method of the provision unit for AR/VR devices or wearable terminals. Furthermore, advanced technologies such as transfer learning, federated learning, and self-supervised learning can be applied as learning methods for the AI models of each unit. From the perspective of data flow, configurations that share user attributes and emotion estimation results in real time among all modules to realize dynamic personalization control, or configurations that implement each module as a microservice in a distributed cloud environment to improve scalability and fault tolerance, are also possible. With these diverse variations, the present invention, unlike conventional static information processing systems, can realize a flexible and highly extensible information accessibility platform that combines advanced technologies such as AI, IoT, and cloud. As a technical effect, optimal information provision according to user attributes, situations, emotions, and devices can be realized in various environments, bringing effects such as information barrier-free, operational efficiency, improved user experience, and reduced system operation costs. Applicable fields include smart cities, remote medical care, educational DX, disaster information distribution, and information sharing platforms for global companies.

The registration unit can monitor the user's health status and adjust the input interface for registration information. For example, when the user is tired, a simple interface is provided and the input procedure is minimized. Additionally, when the user is healthy, detailed input options are provided and customizable input methods are proposed. Furthermore, when the user is ill, voice input is prioritized to enable quick entry of registration information. By adjusting the input interface according to the user's health status, the user can register information without stress. Specifically, the registration unit acquires biometric information indicating the user's health status (e.g., heart rate, blood pressure, skin conductance, body temperature, step count data) in real time from wearable sensors or built-in smartphone sensors, and inputs these as time-series numerical arrays or feature vectors to a health status estimation model. Examples of input include: Input 1: heart rate time series+step count data; Input 2: skin conductance+body temperature+blood pressure data; and so on. As health status estimation models, recurrent neural networks (RNN), convolutional neural networks (CNN), or multimodal fusion transformer models can be used. The model outputs health status labels such as “healthy,” “fatigued,” “ill,” and probability distributions (e.g., fatigue level 0.6, health level 0.3) from the input data. Examples of output include: Output 1: health status label “fatigued”; Output 2: health status label “healthy”+probability distribution; Output 3: health status label “ill”+probability distribution; and so on. The registration unit performs threshold judgment on these output results, and when the fatigue level is high, reduces the number of input items; when the health level is high, displays detailed settings; and when the illness level is high, prioritizes voice input and auto-completion functions, automatically switching the interface layout and input procedure. This series of processes, which combines biometric information and high-dimensional features, realizes non-conventional rule-based processing and multi-stage optimization using neural networks, which is fundamentally different from simple human health status judgment, and brings essential improvements to computer technology (e.g., automatic optimization of UI/UX, improvement of user experience, reduction of input errors). As a technical effect, the present invention achieves optimized health status-adaptive input control for each user, and can greatly improve input efficiency, satisfaction, and registration completion rate compared to conventional uniform input interfaces. Applicable fields include health status-adaptive information registration in medical and welfare fields, remote work support systems, and barrier-free input support for people with disabilities.

The collection unit can analyze the user's past purchase history and propose the optimal information collection method. For example, the collection unit preferentially collects information related to products the user has purchased in the past. Additionally, the collection unit can collect information related to product categories that the user frequently purchases. Furthermore, the collection unit can predict and propose information to be collected at specific times based on the user's purchase history. By analyzing the user's purchase history, the optimal information collection method can be proposed, and efficient information collection can be achieved. Specifically, the collection unit acquires purchase history data recorded in chronological order for each user (e.g., product ID, category ID, purchase time, purchase amount, purchase medium) from a database, and inputs these as feature vectors or time-series tensors (e.g., N×F matrix, N=number of history items, F=number of features) to an analysis module. Examples of input include: Input 1: product ID column for the past 30 days+category column+time column; Input 2: number of purchases in specific categories in the past week+purchase trends by day of the week; and so on. As analysis modules, decision trees, random forests, LSTM (long short-term memory) networks for time-series prediction, or clustering algorithms can be used. The model generates outputs such as “recommended information category for next collection,” “recommended collection method,” and “predicted collection time slot” from the input data. Examples of output include: Output 1: recommended category “home appliances,” “books”; Output 2: recommended collection method “API collection,” “web scraping”; Output 3: recommended time slot “18:00-20:00”; and so on. The collection unit uses these output results to realize automatic switching of collection methods, priority display of targets, and reminder notifications for collection timing in the information collection module. Furthermore, variations that detect changes in purchase history or the appearance of new categories in real time and dynamically switch collection targets can also be implemented. This series of processes, which combines purchase history data and high-dimensional features, realizes non-conventional rule-based processing and multi-stage optimization using neural networks, which is fundamentally different from simple human history reference, and brings essential improvements to computer technology (e.g., automation and acceleration of information collection processes, improvement of personalization accuracy, optimization of system load). As a technical effect, the present invention achieves optimized control of purchase history-linked information collection for each user, and can greatly improve collection efficiency, satisfaction, and usage efficiency compared to conventional uniform information collection. Applicable fields include personalized information collection for e-commerce sites, purchase history-linked recommendation systems, and automatic collection of marketing information.

The analysis unit can adjust the method of information analysis by considering the user's hobbies and interests. For example, when the user is interested in sports, the analysis unit preferentially analyzes sports-related information. Additionally, when the user is interested in music, the analysis unit can preferentially analyze music-related information. Furthermore, the analysis unit can analyze related information in detail based on the user's hobbies and interests. By adjusting the method of information analysis according to the user's hobbies and interests, efficient information analysis can be achieved. Specifically, the analysis unit acquires hobby and interest data entered by the user (e.g., category ID, keyword list, past browsing history) as structured vectors (e.g., category=2, keywords=“soccer, music”), and inputs these as input features to an information analysis algorithm. Examples of input include: Input 1: category “sports”+keyword “soccer”; Input 2: category “music”+keyword “classical”; and so on. As information analysis algorithms, rule-based filtering, keyword matching, or neural networks that take hobby and interest vectors as input (e.g., multilayer perceptron, models combining topic modeling) can be used. The model outputs a “priority analysis information list” and a “detailed analysis target list” from the input data. Examples of output include: Output 1: priority analysis “latest soccer news,” “match results”; Output 2: priority analysis “classical music event information”; and so on. The analysis unit automatically selects analysis targets and optimizes analysis order in the analysis pipeline based on these output results, realizing information analysis optimized for the user's hobbies and interests. Furthermore, variations that detect changes in hobbies and interests in real time and dynamically switch analysis targets can also be implemented. This series of processes, which combines hobby and interest data and high-dimensional features, realizes non-conventional rule-based processing and multi-stage optimization using neural networks, which is fundamentally different from simple human interest reference, and brings essential improvements to computer technology (e.g., automation and acceleration of information analysis processes, improvement of personalization accuracy, optimization of system load). As a technical effect, the present invention achieves optimized control of hobby and interest-linked information analysis for each user, and can greatly improve analysis efficiency, satisfaction, and usage efficiency compared to conventional uniform information analysis. Applicable fields include personalized news analysis, hobby-specific information analysis, and automatic analysis of teaching materials for learners.

The rewriting unit can adjust the method of expression for rewriting based on the user's learning style. For example, when the user is a visual learner, the rewriting unit provides a method of expression that uses many diagrams and graphs. Additionally, when the user is an auditory learner, the rewriting unit can provide a method of expression that includes voice explanations. Furthermore, when the user is an experiential learner, the rewriting unit can provide an interactive method of expression. By adjusting the method of expression for rewriting according to the user's learning style, optimal information provision for the user can be achieved. Specifically, the rewriting unit acquires learning style data entered by the user (e.g., visual=1, auditory=2, experiential=3 as category values) as attribute vectors, and inputs these as input features to an expression method selection algorithm. Examples of input include: Input 1: learning style “visual”+original text; Input 2: learning style “auditory”+original text; Input 3: learning style “experiential”+original text; and so on. As expression method selection algorithms, rule-based mapping tables or neural networks that take learning style vectors as input (e.g., multilayer perceptron) can be used. The model generates outputs such as “text with diagrams,” “text with voice explanations,” and “interactive teaching materials” from the input data. Examples of output include: Output 1: explanatory text with many diagrams and graphs; Output 2: text with links to voice explanations; Output 3: interactive teaching materials including quizzes and simulations; and so on. The rewriting unit uses these output results to realize information presentation optimized for the user's learning style. Furthermore, variations that respond to changes in learning style or combinations of multiple styles can also be implemented. This series of processes, which combines learning style data and high-dimensional features, realizes non-conventional rule-based processing and multi-stage optimization using neural networks, which is fundamentally different from simple human expression switching, and brings essential improvements to computer technology (e.g., automation and acceleration of information presentation processes, improvement of personalization accuracy, optimization of system load). As a technical effect, the present invention achieves optimized control of learning style-adaptive information presentation for each user, and can greatly improve comprehension, satisfaction, and learning efficiency compared to conventional uniform information presentation. Applicable fields include educational support systems, e-learning teaching material generation, and barrier-free information for people with disabilities.

The provision unit can adjust the method of information provision by considering the user's device usage status. For example, when the user is using a smartphone, the provision unit provides mobile-friendly information. Additionally, when the user is using a tablet, the provision unit can provide information suitable for touch operation. Furthermore, when the user is using a desktop, the provision unit can provide information suitable for a large screen. By adjusting the method of information provision according to the user's device usage status, optimal information provision for the user can be achieved. Specifically, the provision unit acquires device type (e.g., smartphone, tablet, desktop, wearable device), screen size, and input method (touch, mouse, voice) from device information APIs or browser information, and inputs these as attribute vectors to an information provision algorithm. Examples of input include: Input 1: device type “smartphone”+screen size 5.5 inches; Input 2: device type “tablet”+touch input; Input 3: device type “desktop”+mouse input; and so on. As information provision algorithms, rule-based UI optimization tables or neural networks that take device attribute vectors as input (e.g., multilayer perceptron) can be used. The model generates outputs such as “mobile-optimized UI,” “touch operation-compatible UI,” and “large-screen UI” from the input data. Examples of output include: Output 1: vertical layout for smartphones; Output 2: enlarged touch button UI for tablets; Output 3: multi-column display UI for desktops; and so on. The provision unit uses these output results to realize information presentation optimized for the user's device usage status. Furthermore, variations that respond in real time to device rotation, screen size changes, and input method switching can also be implemented. This series of processes, which combines device attributes and high-dimensional features, realizes non-conventional rule-based processing and multi-stage optimization using neural networks, which is fundamentally different from simple human device judgment, and brings essential improvements to computer technology (e.g., automatic optimization of UI/UX, improvement of user experience, reduction of errors). As a technical effect, the present invention achieves optimized control of device-adaptive information provision for each user, and can greatly improve comprehension, satisfaction, and usage efficiency compared to conventional uniform information presentation. Applicable fields include mobile-first web services, multi-device-compatible educational systems, and UI optimization for business information terminals.

The registration unit can estimate the user's emotion and adjust the color and design of the input interface for registration information based on the estimated emotion of the user. For example, when the user feels stressed, a calm-colored interface is provided. Additionally, when the user is relaxed, a brightly colored interface can be provided. Furthermore, when the user is in a hurry, a simple and highly visible design can be provided. By adjusting the color and design of the input interface according to the user's emotion, the user can comfortably register information. Specifically, the registration unit acquires the user's input behavior (e.g., keyboard input speed, frequency of input errors, number of input interruptions) and biometric information (e.g., facial images, voice tone, heart rate data) in real time from sensors, cameras, microphones, etc., and inputs these as input tensors (e.g., time-series numerical arrays, image tensors, acoustic feature vectors) to an emotion estimation model. Examples of input include: Input 1: time-series array of keyboard input speed+facial image tensor; Input 2: mel spectrogram of voice waveform+time-series heart rate data; and so on. As emotion estimation models, convolutional neural networks (CNN), recurrent neural networks (RNN), and multimodal fusion transformer models can be used. The model outputs emotion labels such as “stress,” “relaxed,” “in a hurry,” and probability distributions (e.g., stress level 0.7, relaxation level 0.2) from the input data. Examples of output include: Output 1: emotion label “stress”; Output 2: emotion label “relaxed”+probability distribution; Output 3: emotion label “in a hurry”+probability distribution; and so on. The registration unit performs threshold judgment on these output results, and when the stress level is high, automatically applies calm color schemes such as blue or gray; when the relaxation level is high, applies bright color schemes such as yellow or green; and when the hurry level is high, applies simple white backgrounds and large fonts. Furthermore, variations that dynamically select the optimal UI template by combining the user's emotional state and past design history can also be implemented. This series of processes, which combines emotional state and high-dimensional input features, realizes non-conventional rule-based processing and multi-stage optimization using neural networks, which is fundamentally different from simple human color and design selection, and brings essential improvements to computer technology (e.g., automatic optimization of UI/UX, improvement of user experience, reduction of input errors). As a technical effect, the present invention achieves optimized control of emotion-adaptive UI design for each user, and can greatly improve comfort, satisfaction, and input efficiency compared to conventional uniform interfaces. Applicable fields include stress-adaptive input screens in medical and welfare fields, learner-adaptive UI in educational settings, and emotion-detection-based input systems in customer support.

The collection unit can also estimate the user's emotion and adjust the frequency of information collection based on the estimated emotion of the user. For example, when the user is relaxed, the frequency of information collection is lowered. When the user is excited, the frequency of information collection can be increased. Furthermore, when the user is stressed, the frequency of information collection can be adjusted to a moderate level. By adjusting the frequency of information collection according to the user's emotion, efficient information collection can be achieved. Specifically, the collection unit acquires the user's input behavior (e.g., mouse operation speed, click frequency, number of input interruptions) and biometric information (e.g., facial images, voice tone, skin conductance response, etc.) in real time from sensors, cameras, microphones, and the like, and inputs these as input tensors (e.g., time-series numerical arrays, image tensors, acoustic feature vectors) into an emotion estimation model. Examples of input include: Input 1: time-series array of mouse movement speed+facial image tensor; Input 2: mel spectrogram of voice waveform+time-series data of skin conductance response, and so on. As the emotion estimation model, a convolutional neural network (CNN), recurrent neural network (RNN), or multimodal fusion transformer model can be used. The model outputs emotion labels such as “relaxed,” “excited,” “stressed,” and probability distributions (e.g., relaxation level 0.7, excitement level 0.2, etc.) from the input data. Examples of output include: Output 1: emotion label “relaxed”; Output 2: emotion label “excited”+probability distribution; Output 3: emotion label “stressed”+probability distribution, and so on. The collection unit performs threshold determination on these output results, and automatically optimizes the timing of information collection, such as lengthening the interval between collections when the relaxation level is high, increasing the collection frequency when the excitement level is high, and adjusting to a moderate frequency when the stress level is high. Furthermore, variations are possible in which changes in emotional state are detected in real time and the collection frequency is dynamically switched. This series of processing, unlike simple frequency adjustment by humans, realizes non-conventional rule-based processing and multi-stage optimization by neural networks that combine emotional states and high-dimensional input features, thereby fundamentally improving computer technology (e.g., automation and acceleration of information collection processes, improvement of personalization accuracy, optimization of system load). As a technical effect, the present invention realizes emotion-adaptive information collection frequency control optimized for each user, and can greatly improve collection efficiency, satisfaction, and utilization efficiency compared to conventional uniform information collection. Application fields include stress-adaptive information collection in medical and welfare fields, learner-adaptive information acquisition in educational settings, and emotion-detection-based information collection systems for customer support.

The analysis unit can also estimate the user's emotion and adjust the display format of the analysis results based on the estimated emotion of the user. For example, when the user is nervous, a simple and highly visible display format is provided. When the user is relaxed, a display format including detailed information can also be provided. Furthermore, when the user is in a hurry, a display format focusing on key points can also be provided. By adjusting the display format of the analysis results according to the user's emotion, the optimal display format can be provided to the user. Specifically, the analysis unit acquires the user's input behavior (e.g., keyboard input speed, frequency of input errors, number of input interruptions) and biometric information (e.g., facial images, voice tone, heart rate data) in real time from sensors, cameras, microphones, and the like, and inputs these as input tensors (e.g., time-series numerical arrays, image tensors, acoustic feature vectors) into an emotion estimation model. Examples of input include: Input 1: time-series array of keyboard input speed+facial image tensor; Input 2: mel spectrogram of voice waveform+time-series data of heart rate, and so on. As the emotion estimation model, a convolutional neural network (CNN), recurrent neural network (RNN), or multimodal fusion transformer model can be used. The model outputs emotion labels such as “nervous,” “relaxed,” “in a hurry,” and probability distributions (e.g., nervousness level 0.7, relaxation level 0.2, etc.) from the input data. Examples of output include: Output 1: emotion label “nervous”; Output 2: emotion label “relaxed”+probability distribution; Output 3: emotion label “in a hurry”+probability distribution, and so on. The analysis unit performs threshold determination on these output results, and automatically switches the display format, such as providing a simple card-type UI or emphasized display with large fonts and color coding when the nervousness level is high, providing a rich UI with detailed graphs and supplementary explanations when the relaxation level is high, and displaying only key points in a bulleted list when the “in a hurry” level is high. Furthermore, variations are possible in which the user's emotional state and past display history are combined to dynamically select the optimal display template. This series of processing, unlike simple display switching by humans, realizes non-conventional rule-based processing and multi-stage optimization by neural networks that combine emotional states and high-dimensional input features, thereby fundamentally improving computer technology (e.g., automatic optimization of UI/UX, improvement of user experience, reduction of errors). As a technical effect, the present invention realizes emotion-adaptive analysis result display control optimized for each user, and can greatly improve understanding, satisfaction, and utilization efficiency compared to conventional uniform display. Application fields include stress-adaptive information display in medical and welfare fields, learner-adaptive UI in educational settings, and emotion-detection-based information presentation systems for customer support.

The rewriting unit can also estimate the user's emotion and adjust the tone of rewriting based on the estimated emotion of the user. For example, when the user is relaxed, a friendly and approachable tone is provided. When the user is nervous, a formal and calm tone can also be provided. Furthermore, when the user is excited, an energetic and lively tone can also be provided. By adjusting the tone of rewriting according to the user's emotion, optimal information provision for the user can be realized. Specifically, the rewriting unit acquires the user's input behavior (e.g., keyboard input speed, frequency of input errors, number of input interruptions) and biometric information (e.g., facial images, voice tone, heart rate data) in real time from sensors, cameras, microphones, and the like, and inputs these as input tensors (e.g., time-series numerical arrays, image tensors, acoustic feature vectors) into an emotion estimation model. Examples of input include: Input 1: time-series array of keyboard input speed+facial image tensor; Input 2: mel spectrogram of voice waveform+time-series data of heart rate, and so on. As the emotion estimation model, a convolutional neural network (CNN), recurrent neural network (RNN), or multimodal fusion transformer model can be used. The model outputs emotion labels such as “relaxed,” “nervous,” “excited,” and probability distributions (e.g., relaxation level 0.7, nervousness level 0.2, etc.) from the input data. Examples of output include: Output 1: emotion label “relaxed”; Output 2: emotion label “nervous”+probability distribution; Output 3: emotion label “excited”+probability distribution, and so on. The rewriting unit performs threshold determination on these output results, and automatically applies friendly sentence endings and approachable expressions when the relaxation level is high, formal honorifics and calm expressions when the nervousness level is high, and energetic vocabulary and emphatic expressions when the excitement level is high. Furthermore, variations are possible in which the user's emotional state and past tone history are combined to dynamically select the optimal tone template. This series of processing, unlike simple tone selection by humans, realizes non-conventional rule-based processing and multi-stage optimization by neural networks that combine emotional states and high-dimensional input features, thereby fundamentally improving computer technology (e.g., automatic optimization of UI/UX, improvement of user experience, reduction of errors). As a technical effect, the present invention realizes emotion-adaptive tone control optimized for each user, and can greatly improve understanding, satisfaction, and utilization efficiency compared to conventional uniform information presentation. Application fields include stress-adaptive information presentation in medical and welfare fields, learner-adaptive teaching material generation in educational settings, and emotion-detection-based information presentation systems for customer support.

The provision unit can also estimate the user's emotion and adjust the timing of information provision based on the estimated emotion of the user. For example, when the user is relaxed, information provision is performed slowly. When the user is in a hurry, information provision can be performed quickly. Furthermore, when the user is excited, information provision can be performed quickly and efficiently. By adjusting the timing of information provision according to the user's emotion, efficient information provision can be realized. Specifically, the provision unit acquires the user's input behavior (e.g., mouse operation speed, click frequency, number of input interruptions) and biometric information (e.g., facial images, voice tone, heart rate data) in real time from sensors, cameras, microphones, and the like, and inputs these as input tensors (e.g., time-series numerical arrays, image tensors, acoustic feature vectors) into an emotion estimation model. Examples of input include: Input 1: time-series array of keyboard input speed+facial image tensor; Input 2: mel spectrogram of voice waveform+time-series data of heart rate, and so on. As the emotion estimation model, a convolutional neural network (CNN), recurrent neural network (RNN), or multimodal fusion transformer model can be used. The model outputs emotion labels such as “relaxed,” “in a hurry,” “excited,” and probability distributions (e.g., relaxation level 0.7, “in a hurry” level 0.2, etc.) from the input data. Examples of output include: Output 1: emotion label “relaxed”; Output 2: emotion label “in a hurry”+probability distribution; Output 3: emotion label “excited”+probability distribution, and so on. The provision unit performs threshold determination on these output results, and automatically optimizes the timing of information provision, such as lengthening the interval between provisions when the relaxation level is high, increasing the provision frequency when the “in a hurry” level is high, and presenting multiple pieces of information in parallel when the excitement level is high. Furthermore, variations are possible in which changes in emotional state are detected in real time and the provision timing is dynamically switched. This series of processing, unlike simple timing adjustment by humans, realizes non-conventional rule-based processing and multi-stage optimization by neural networks that combine emotional states and high-dimensional input features, thereby fundamentally improving computer technology (e.g., automation and acceleration of information provision processes, improvement of personalization accuracy, optimization of system load). As a technical effect, the present invention realizes emotion-adaptive information provision timing control optimized for each user, and can greatly improve understanding, satisfaction, and utilization efficiency compared to conventional uniform information provision. Application fields include stress-adaptive information presentation in medical and welfare fields, learner-adaptive information provision in educational settings, and emotion-detection-based information presentation systems for customer support.

The following is a brief description of the processing flow of Example of the Embodiment. Specifically, in this system, each module—the registration unit, collection unit, analysis unit, rewriting unit, and provision unit—operates in cooperation. In Step 1, the registration unit transmits attribute information such as the user's nationality, gender, education level, and IT literacy level to the server as structured data (e.g., attribute vectors in JSON format, with each attribute represented by a numerical or categorical value) via input interfaces such as web forms or mobile apps, and stores it in the user profile database. In Step 2, the collection unit uses the attribute vector registered by the registration unit as personalization conditions to collect text data from various information media such as news articles, academic papers, and blog posts using methods such as web APIs, RSS feeds, and scraping, and temporarily stores the data as UTF-8 encoded text files or tensors divided by paragraph (e.g., N×L character ID arrays). In Step 3, the analysis unit inputs multi-input tensors combining the information acquired by the collection unit and the user attribute vector into a large-scale language model (e.g., transformer-based encoder-decoder model), performs multi-stage processing such as extraction of important terms, estimation of technical term difficulty, and style conversion, and generates text optimized for the user's attributes. In Step 4, the rewriting unit automatically replaces the information analyzed by the analysis unit with plain words or explanatory text according to the user's education level and IT literacy using algorithms such as technical term extraction, difficulty estimation, and context-adaptive substitution, and rewrites it into optimal expressions. The rewriting unit uses generative AI (e.g., transformer-based large-scale language models) to perform multi-stage conversion considering additional attributes such as emotion and learning style. In Step 5, the provision unit presents the information rewritten by the rewriting unit with the optimal UI/UX according to the user's emotional state and device usage. The provision unit also cooperates with subsequent modules such as a speech synthesis unit and a diagram generation unit to realize information provision optimized for each user. This series of processing, by combining attribute vectors and emotion estimation results with high-dimensional text tensors, realizes non-conventional rule-based processing and multi-stage optimization by neural networks, thereby fundamentally improving computer technology (e.g., automation and acceleration of information processing, improvement of personalization accuracy, and barrier-free information access). As a technical effect, the present invention realizes information provision optimized for each user, and can greatly improve understanding, satisfaction, and utilization efficiency compared to conventional uniform information distribution. Application fields include educational support systems, administrative information distribution, medical information provision, internal information sharing in global companies, and barrier-free information access for people with disabilities.

Step 1: The registration unit registers the user's nationality, gender, education level, and IT literacy level. The information registered by the user includes, for example, nationality, gender, education level, and IT literacy level. The registration unit provides an interface for the user to input their nationality, gender, education level, and IT literacy level. Step 2: The collection unit acquires information from various information media based on the information registered by the registration unit. The collection unit can acquire information from information media such as news articles, academic papers, and blog posts, and collect information from sources on the Internet. Step 3: The analysis unit analyzes the information acquired by the collection unit. The analysis unit analyzes the acquired information and selects appropriate information based on the user's registration information. The analysis unit can analyze information using natural language processing technology. Step 4: The rewriting unit rewrites the information analyzed by the analysis unit into a form suitable for the user. The rewriting unit converts information containing many technical terms into words that are easily understood by the general public. The rewriting unit can convert information using generative AI. Step 5: The provision unit provides the information rewritten by the rewriting unit to the user. The provision unit provides an interface for providing the rewritten information to the user. Specifically, in this system, the registration unit transmits the user's attribute information to the server as structured data (e.g., attribute vectors in JSON format) via input interfaces such as web forms or mobile apps, and stores it in the user profile database. The collection unit uses the attribute vector as personalization conditions to collect text data using methods such as web APIs, RSS feeds, and scraping, and temporarily stores the data as text files or tensors. The analysis unit inputs multi-input tensors combining the user attribute vector and collected text tensors into a large-scale language model, and performs multi-stage processing such as extraction of important terms, estimation of technical term difficulty, and style conversion. The rewriting unit automatically replaces technical terms with plain words or explanatory text according to the user's education level and IT literacy using algorithms such as technical term extraction, difficulty estimation, and context-adaptive substitution, and rewrites it into optimal expressions. The provision unit presents the rewritten information with the optimal UI/UX according to the user's emotional state and device usage. This series of processing, by combining attribute vectors and emotion estimation results with high-dimensional text tensors, realizes non-conventional rule-based processing and multi-stage optimization by neural networks, thereby fundamentally improving computer technology (e.g., automation and acceleration of information processing, improvement of personalization accuracy, and barrier-free information access). As a technical effect, the present invention realizes information provision optimized for each user, and can greatly improve understanding, satisfaction, and utilization efficiency compared to conventional uniform information distribution. Application fields include educational support systems, administrative information distribution, medical information provision, internal information sharing in global companies, and barrier-free information access for people with disabilities.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned registration unit, collection unit, analysis unit, rewriting unit, and provision unit is implemented by at least one of, for example, a smart device 14 and a data processing apparatus 12. For example, the registration unit is implemented by a control unit 46A of the smart device 14 and provides an interface for registering a user's nationality, gender, education level, and IT literacy level. The collection unit is implemented, for example, by a specific processing unit 290 of the data processing apparatus 12 and collects information from information sources on the Internet. The analysis unit is implemented, for example, by the specific processing unit 290 of the data processing apparatus 12 and analyzes information using natural language processing technology. The rewriting unit is implemented, for example, by the specific processing unit 290 of the data processing apparatus 12 and converts information containing many technical terms into words that are easily understood by the general public. The provision unit is implemented, for example, by the control unit 46A of the smart device 14 and provides an interface for providing the rewritten information to the user. The correspondence between each unit and the apparatus or control unit is not limited to the examples described above and various modifications are possible.

### Second Embodiment

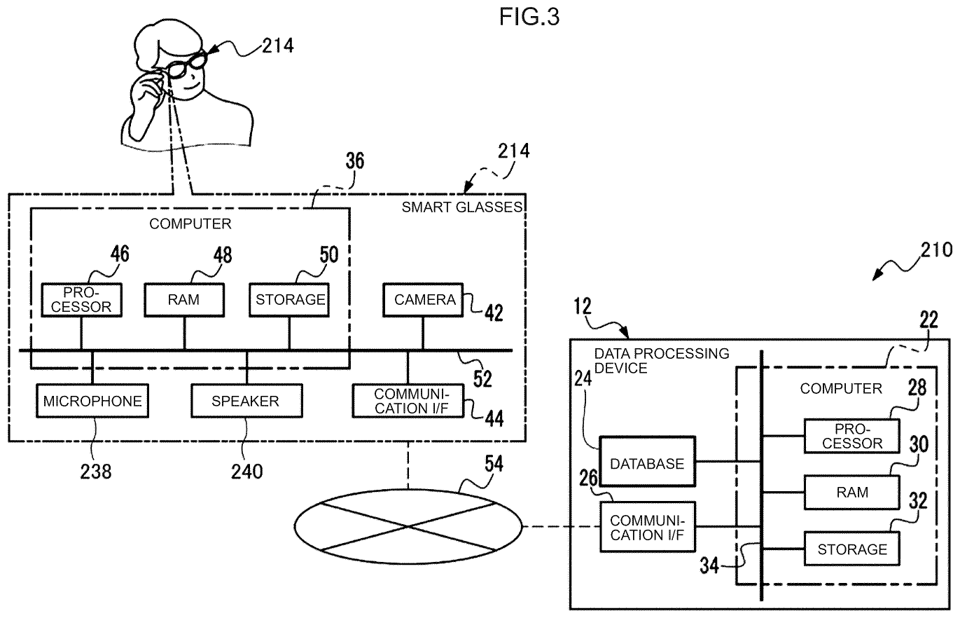

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

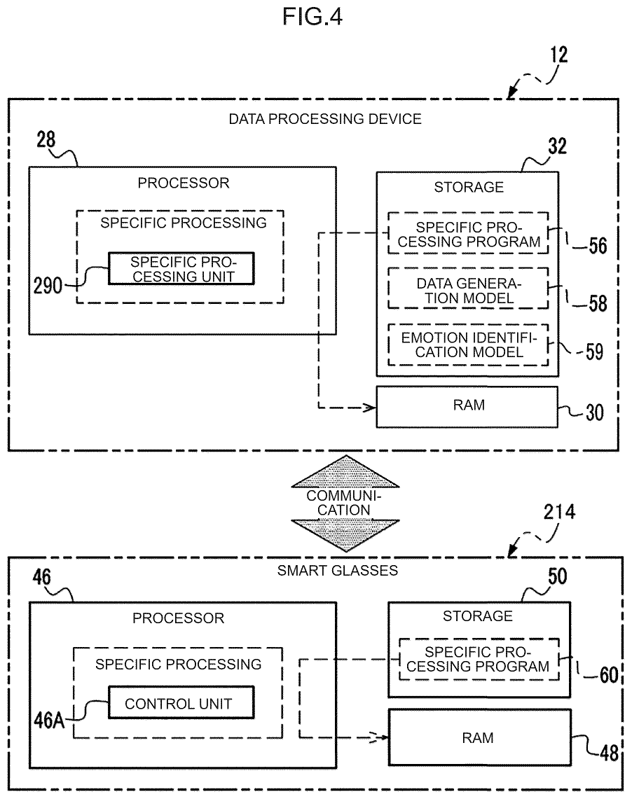

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned registration unit, collection unit, analysis unit, rewriting unit, and provision unit is implemented by at least one of, for example, smart glasses 214 and a data processing apparatus 12. For example, the registration unit is implemented by a control unit 46A of the smart glasses 214 and provides an interface for registering a user's nationality, gender, education level, and IT literacy level. The collection unit is implemented, for example, by a specific processing unit 290 of the data processing apparatus 12 and collects information from information sources on the Internet. The analysis unit is implemented, for example, by the specific processing unit 290 of the data processing apparatus 12 and analyzes information using natural language processing technology. The rewriting unit is implemented, for example, by the specific processing unit 290 of the data processing apparatus 12 and converts information containing many technical terms into words that are easily understood by the general public. The provision unit is implemented, for example, by the control unit 46A of the smart glasses 214 and provides an interface for providing the rewritten information to the user. The correspondence between each unit and the apparatus or control unit is not limited to the examples described above and various modifications are possible.

### Third Embodiment

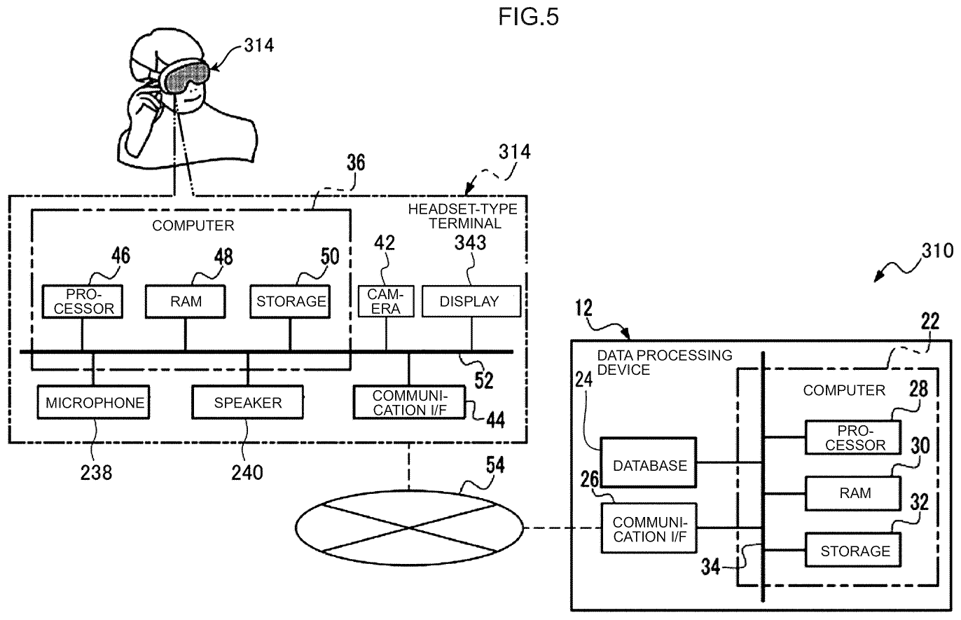

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

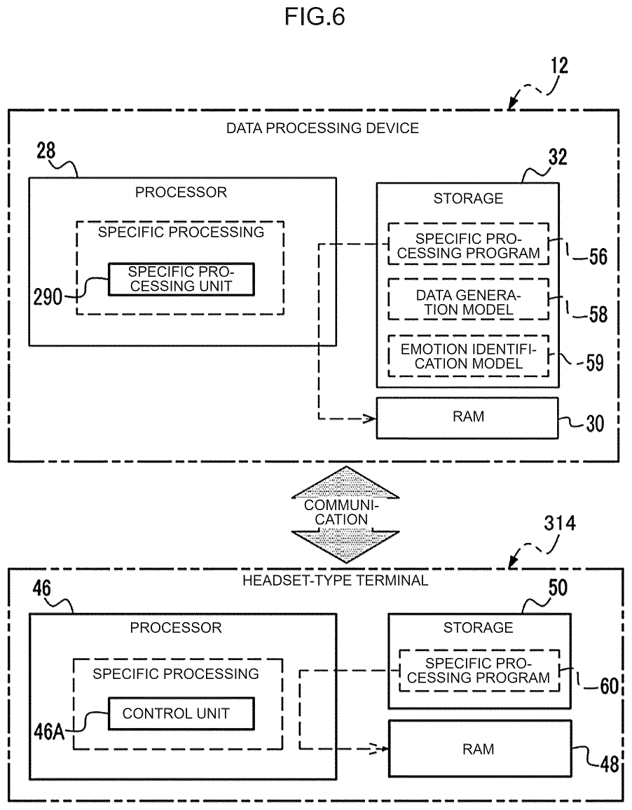

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned registration unit, collection unit, analysis unit, rewriting unit, and provision unit is implemented by at least one of, for example, a headset-type terminal 314 and a data processing apparatus 12. For example, the registration unit is implemented by a control unit 46A of the headset-type terminal 314 and provides an interface for registering a user's nationality, gender, education level, and IT literacy level. The collection unit is implemented, for example, by a specific processing unit 290 of the data processing apparatus 12 and collects information from information sources on the Internet. The analysis unit is implemented, for example, by the specific processing unit 290 of the data processing apparatus 12 and analyzes information using natural language processing technology. The rewriting unit is implemented, for example, by the specific processing unit 290 of the data processing apparatus 12 and converts information containing many technical terms into words that are easily understood by the general public. The provision unit is implemented, for example, by the control unit 46A of the headset-type terminal 314 and provides an interface for providing the rewritten information to the user. The correspondence between each unit and the apparatus or control unit is not limited to the examples described above and various modifications are possible.

### Fourth Embodiment

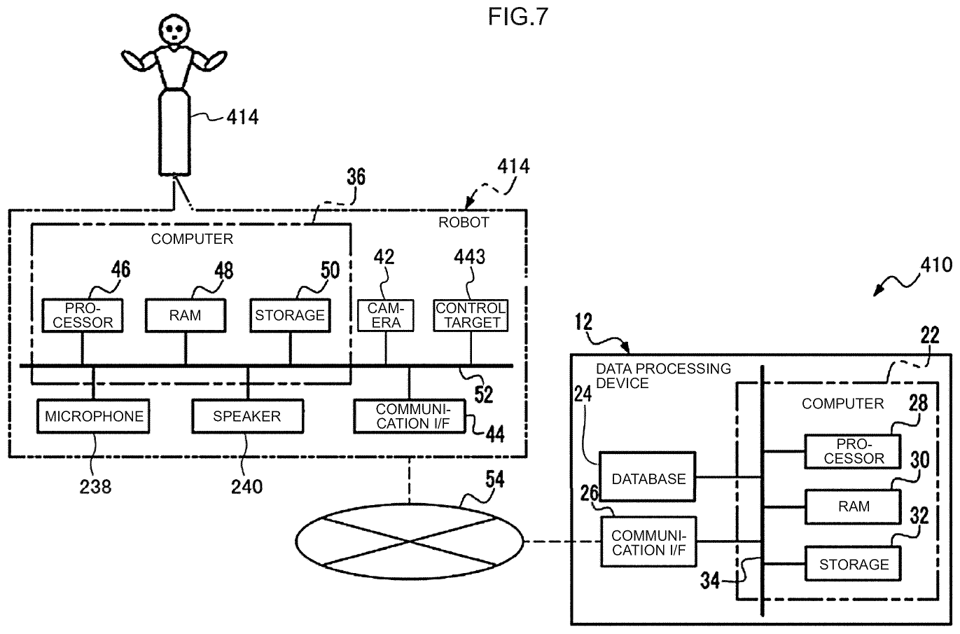

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

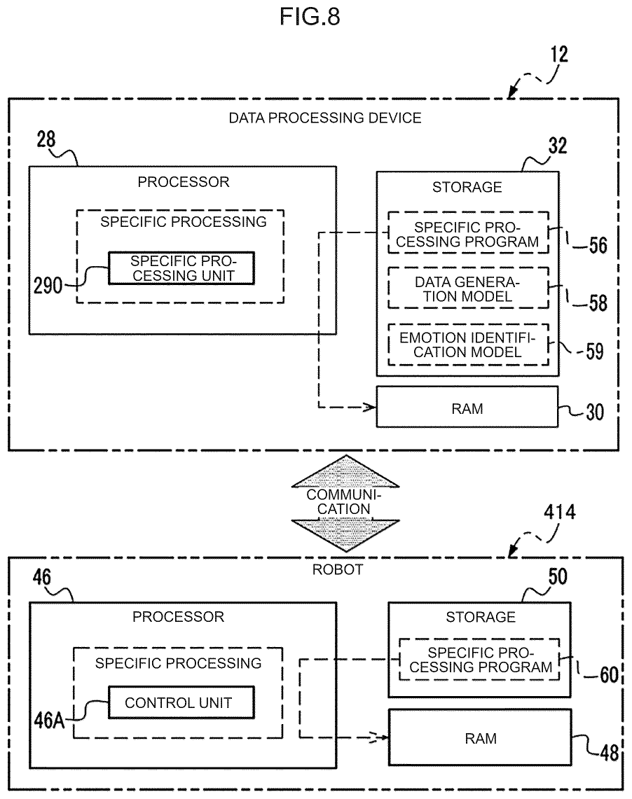

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned registration unit, collection unit, analysis unit, rewriting unit, and provision unit is implemented by at least one of, for example, a robot 414 and a data processing apparatus 12. For example, the registration unit is implemented by a control unit 46A of the robot 414 and provides an interface for registering a user's nationality, gender, education level, and IT literacy level. The collection unit is implemented, for example, by a specific processing unit 290 of the data processing apparatus 12 and collects information from information sources on the Internet. The analysis unit is implemented, for example, by the specific processing unit 290 of the data processing apparatus 12 and analyzes information using natural language processing technology. The rewriting unit is implemented, for example, by the specific processing unit 290 of the data processing apparatus 12 and converts information containing many technical terms into words that are easily understood by the general public. The provision unit is implemented, for example, by the control unit 46A of the robot 414 and provides an interface for providing the rewritten information to the user. The correspondence between each unit and the apparatus or control unit is not limited to the examples described above and various modifications are possible.

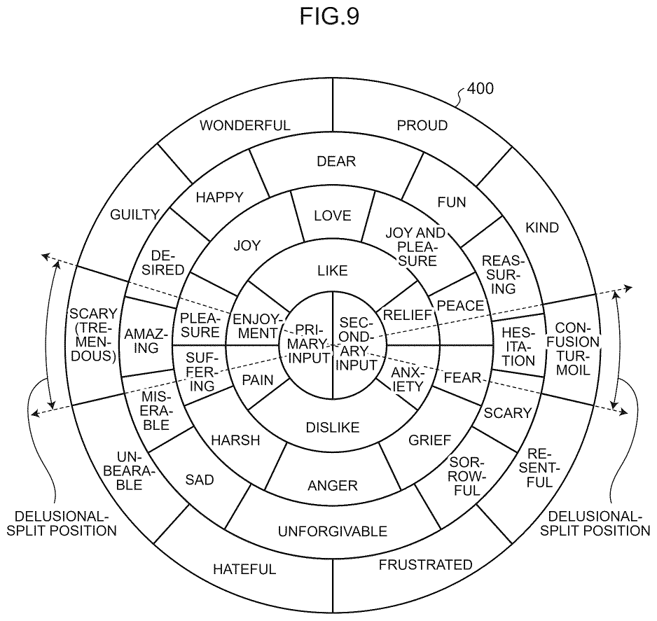

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

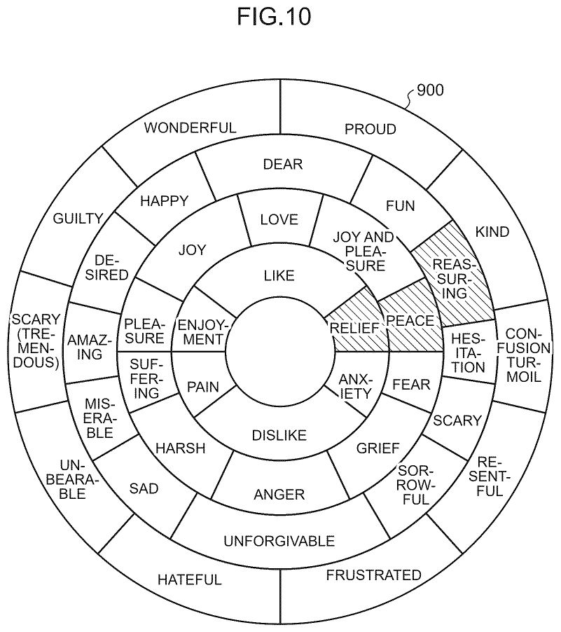

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1)A system comprising: a registration unit configured to register a user's nationality, gender, education level, and IT literacy level; a collection unit configured to acquire information from various information media based on the information registered by the registration unit; an analysis unit configured to analyze the information acquired by the collection unit; a rewriting unit configured to rewrite the information analyzed by the analysis unit into a form suitable for the user; and a provision unit configured to provide the information rewritten by the rewriting unit to the user.
(Supplementary Note 2)The system according to Supplementary Note 1, wherein the registration unit is configured to estimate the user's emotion and adjust the input interface for registration information based on the estimated emotion of the user.
(Supplementary Note 3)The system according to Supplementary Note 1, wherein the registration unit is configured to analyze the user's past registration history and propose an appropriate registration method.
(Supplementary Note 4)The system according to Supplementary Note 1, wherein the registration unit is configured to customize input items at the time of registration based on the user's current situation and areas of interest.
(Supplementary Note 5)The system according to Supplementary Note 1, wherein the registration unit is configured to estimate the user's emotion and adjust the order of input for registration information based on the estimated emotion of the user.
(Supplementary Note 6)The system according to Supplementary Note 1, wherein the registration unit is configured to preferentially display highly relevant input items at the time of registration based on the user's geographic location information.
(Supplementary Note 7)The system according to Supplementary Note 1, wherein the registration unit is configured to analyze the user's social media activity at the time of registration and propose relevant input items.
(Supplementary Note 8)The system according to Supplementary Note 1, wherein the collection unit is configured to estimate the user's emotion and adjust the timing of information collection based on the estimated emotion of the user.
(Supplementary Note 9)The system according to Supplementary Note 1, wherein the collection unit is configured to analyze the user's past information collection history and select an optimal collection method.
(Supplementary Note 10)The system according to Supplementary Note 1, wherein the collection unit is configured to perform filtering during information collection in consideration of the user's current areas of interest.
(Supplementary Note 11)The system according to Supplementary Note 1, wherein the collection unit is configured to estimate the user's emotion and determine the priority of information to be collected based on the estimated emotion of the user.
(Supplementary Note 12)The system according to Supplementary Note 1, wherein the collection unit is configured to preferentially collect highly relevant information during information collection in consideration of the user's geographic location information.
(Supplementary Note 13)The system according to Supplementary Note 1, wherein the collection unit is configured to analyze the user's social media activity during information collection and collect relevant information.
(Supplementary Note 14)The system according to Supplementary Note 1, wherein the analysis unit is configured to estimate the user's emotion and adjust the method of information analysis based on the estimated emotion of the user.
(Supplementary Note 15)The system according to Supplementary Note 1, wherein the analysis unit is configured to adjust the level of detail of analysis during analysis based on the importance of the information.
(Supplementary Note 16)The system according to Supplementary Note 1, wherein the analysis unit is configured to apply different analysis algorithms during analysis according to the category of the information.
(Supplementary Note 17)The system according to Supplementary Note 1, wherein the analysis unit is configured to estimate the user's emotion and adjust the display method of analysis results based on the estimated emotion of the user.
(Supplementary Note 18)The system according to Supplementary Note 1, wherein the analysis unit is configured to determine the priority of analysis during analysis based on the submission timing of the information.
(Supplementary Note 19)The system according to Supplementary Note 1, wherein the analysis unit is configured to adjust the order of analysis during analysis based on the relevance of the information.
(Supplementary Note 20)The system according to Supplementary Note 1, wherein the rewriting unit is configured to estimate the user's emotion and adjust the method of expression for rewriting based on the estimated emotion of the user.
(Supplementary Note 21)The system according to Supplementary Note 1, wherein the rewriting unit is configured to convert technical terms in the information into words that are easily understood by the general public during rewriting.
(Supplementary Note 22)The system according to Supplementary Note 1, wherein the rewriting unit is configured to apply different rewriting algorithms during rewriting according to the category of the information.
(Supplementary Note 23)The system according to Supplementary Note 1, wherein the rewriting unit is configured to estimate the user's emotion and adjust the length of rewriting based on the estimated emotion of the user.
(Supplementary Note 24)The system according to Supplementary Note 1, wherein the rewriting unit is configured to determine the priority of rewriting during rewriting based on the submission timing of the information.
(Supplementary Note 25)The system according to Supplementary Note 1, wherein the rewriting unit is configured to adjust the order of rewriting during rewriting based on the relevance of the information.
(Supplementary Note 26)The system according to Supplementary Note 1, wherein the provision unit is configured to estimate the user's emotion and adjust the method of information provision based on the estimated emotion of the user.
(Supplementary Note 27)The system according to Supplementary Note 1, wherein the provision unit is configured to refer to the user's past information provision history during provision and select an optimal provision method.
(Supplementary Note 28)The system according to Supplementary Note 1, wherein the provision unit is configured to customize the means of information provision during provision based on the user's current situation.
(Supplementary Note 29)The system according to Supplementary Note 1, wherein the provision unit is configured to estimate the user's emotion and determine the priority of information provision based on the estimated emotion of the user.
(Supplementary Note 30)The system according to Supplementary Note 1, wherein the provision unit is configured to select an optimal information provision method during provision in consideration of the user's geographic location information.
(Supplementary Note 31)The system according to Supplementary Note 1, wherein the provision unit is configured to analyze the user's social media activity during provision and propose means of information provision.

What is claimed is:

1. A system comprising:
circuitry configured to:
receive, from a client terminal via a packet-switched network, user attribute data indicating a nationality value, a gender value, an education level value, and an information technology literacy value associated with a user;
store the user attribute data as a user attribute vector in a user profile;
acquire text data from a plurality of information sources via network application programming interfaces;
generate an analysis tensor by inputting the text data and the user attribute vector into a transformer-based encoder-decoder model;
generate transformed text data by processing the analysis tensor through the transformer-based encoder-decoder model, wherein the transformer-based encoder-decoder model applies attribute-conditioned processing to adapt the text data based on the user attribute vector; and
transmit the transformed text data to the client terminal via the packet-switched network.

2. The system according to claim 1, wherein the circuitry is further configured to:
acquire biometric sensor data from the client terminal;
generate an emotion tensor by inputting the biometric sensor data into an emotion identification model; and
adjust an input interface configuration for receiving the user attribute data based on the emotion tensor.

3. The system according to claim 2, wherein the biometric sensor data comprises at least one of facial image data, voice waveform data, or heart rate data.

4. The system according to claim 2, wherein the emotion identification model comprises a multimodal fusion transformer model configured to output an emotion label and a probability distribution.

5. The system according to claim 1, wherein the circuitry is further configured to:
analyze a registration history associated with the user; and
generate a recommended registration method based on the registration history using a long short-term memory network.

6. The system according to claim 1, wherein the circuitry is further configured to:
receive geographic location data from the client terminal; and
adjust a priority ordering of input items for the user attribute data based on the geographic location data.

7. The system according to claim 1, wherein the circuitry is further configured to:
acquire social media activity data associated with the user via a social media application programming interface; and
generate recommended input items for the user attribute data based on the social media activity data using a graph neural network.

8. The system according to claim 1, wherein the circuitry is further configured to:
acquire the text data from at least one of news articles, academic papers, or blog articles via the network application programming interfaces.

9. The system according to claim 1, wherein the circuitry is further configured to:
generate an importance score for the text data; and
adjust a level of detail of the attribute-conditioned processing based on the importance score.

10. The system according to claim 1, wherein the transformer-based encoder-decoder model comprises between one billion and one hundred billion parameters.

11. The system according to claim 1, wherein the attribute-conditioned processing comprises:
extracting technical terms from the text data;
estimating a difficulty score for each technical term; and
replacing technical terms having difficulty scores exceeding a threshold with simplified explanatory text based on the education level value.

12. The system according to claim 1, wherein the user attribute vector comprises a multidimensional feature vector representing the nationality value, the gender value, the education level value, and the information technology literacy value as categorical numerical values.

13. The system according to claim 1, wherein the circuitry is further configured to:
acquire biometric sensor data from the client terminal;
generate an emotion tensor by inputting the biometric sensor data into an emotion identification model; and
adjust a length of the transformed text data based on the emotion tensor.

14. The system according to claim 1, wherein the circuitry is further configured to:
generate a relevance score between the text data and the user attribute vector; and
adjust a processing priority of the text data based on the relevance score.

15. The system according to claim 1, wherein the circuitry is further configured to:
receive geographic location data from the client terminal; and
filter the text data acquired from the plurality of information sources based on the geographic location data.

16. The system according to claim 1, wherein the analysis tensor comprises a multi-input tensor combining the user attribute vector and a text token sequence derived from the text data.

17. The system according to claim 1, wherein the transformer-based encoder-decoder model is configured to perform attribute-conditioned fine-tuning using a loss function conditioned on the user attribute vector.

18. A system comprising:
a communication interface configured to communicate with a client terminal via a packet-switched network;
a processor;
a random-access memory; and
a non-volatile memory storing a transformer-based encoder-decoder model and an emotion identification model, wherein the processor is configured to execute instructions stored in the non-volatile memory to cause the system to:
receive, via the communication interface, user attribute data indicating a nationality value, a gender value, an education level value, and an information technology literacy value associated with a user;
store the user attribute data as a user attribute vector;
receive, via the communication interface, biometric sensor data from the client terminal;
generate an emotion label by inputting the biometric sensor data into the emotion identification model;
acquire text data from a plurality of information sources via network application programming interfaces;
generate an analysis tensor by combining the text data, the user attribute vector, and the emotion label;
generate transformed text data by processing the analysis tensor through the transformer-based encoder-decoder model; and
transmit, via the communication interface, the transformed text data to the client terminal.

19. The system according to claim 18, wherein the emotion identification model comprises a convolutional neural network configured to process the biometric sensor data and output a probability distribution over a plurality of emotion labels.

20. A method performed by circuitry of a system, the method comprising:
receiving, from a client terminal via a packet-switched network, user attribute data indicating a nationality value, a gender value, an education level value, and an information technology literacy value associated with a user;
storing the user attribute data as a user attribute vector in a user profile;
acquiring text data from a plurality of information sources via network application programming interfaces;
generating an analysis tensor by inputting the text data and the user attribute vector into a transformer-based encoder-decoder model;
generating transformed text data by processing the analysis tensor through the transformer-based encoder-decoder model, wherein the transformer-based encoder-decoder model applies attribute-conditioned processing to adapt the text data based on the user attribute vector; and
transmitting the transformed text data to the client terminal via the packet-switched network.
